(19) United States
(12) Patent Application Publication
(10) Pub. No.: US 2024/0408758 A1
(43) Pub. Date: Dec. 12, 2024

(54) GENERATIVE ADVERSARIAL NETWORKS FOR DETECTING ERRONEOUS RESULTS

(71) Applicant: TRACLABS, INC., WEBSTER, TX (US)

(72) Inventors: MICHAEL W. LANIGHAN, PEARLAND, TX (US); OSCAR M. YOUNGQUIST, SUNDERLAND, MA (US)

(73) Assignee: TRACLABS, INC., WEBSTER, TX (US)

(21) Appl. No.: 18/659,998

(22) Filed: May 9, 2024

Related U.S. Application Data
(60) Provisional application No. 63/500,984, filed on May 9, 2023.

(51) Int. Cl. B25J 9/16; G05B 13/02

(52) U.S. Cl. CPC B25J 9/1674; G05B 13/028

(57) ABSTRACT

Systems and methods leveraging machine learning models to provide error detection in robotic systems. Generative adversarial networks are utilized to provide detection of off-nominal behaviors that may be flagged for user review or cause termination of any pending operations. A positive manifold may be used to reduce overhead in building error detection systems as this reduces the amount of training data required.

### CITATION TO PRIOR APPLICATIONS

The present claims priority to U.S. Provisional Application No. 63/500,984, titled “GENERATIVE ADVERSARIAL NETWORKS FOR DETECTING ERRONEOUS RESULTS,” filed on May 9, 2023. U.S. Provisional Application No. 63/500,984 and all of its cited references are entirely incorporated by reference herein.

### BACKGROUND

As part of the broader Artemis effort, NASA's Human Exploration and Operations Mission Directorate (HEOMD) began targeting an increase in the use of robot and automated systems to enable the unattended setup, operation, and maintenance of ground systems and systems on the surfaces of other planets and moons. There is a critical need for technology to realize this target, specifically technologies to enable automated/autonomous inspection, maintenance, and repair (IM&R). Existing supervisory control frameworks, such as TRACLab's CRAFTSMAN system, have shown promise in enabling IM&R by relying on a shared autonomy paradigm. However, these approaches still require supervisory/operator interaction to perform verification of task outcomes and inspection. This potentially limits the ability to widely deploy such a supervisory system due to the level of required operator attention and interaction. Techniques to automate such tasks are needed to reduce operator burden. Additionally, the lack of robust error detection becomes increasingly critical in remote tasks on the lunar surface and in dangerous ground-based tasks such as those involving propellant transfer.

Recent and on-going work has investigated how to extend the CRAFTSMAN supervisory robot control framework along multiple fronts, including reactive control, intelligent grasp planning, and multi-agent systems. These investigations include ongoing work extending CRAFTSMAN for use in OSAM and lunar surface operations. That work has focused on developing techniques to control and coordinate multi-agent systems to perform various ground operation tasks such as maintenance and inspection and to support remote operation of lunar assets. However, as noted above, these approaches have numerous shortcomings including the requirement of supervisory/operator interaction to perform verification of task outcomes and inspection. To address these shortcoming and to increase the autonomous capabilities of robot control suites for use in HEOMD domains, this disclosure sets out a Generative Adversarial Networks for Detecting Erroneous Results (GANDER) system to leverage generative adversarial networks to perform online error detection in ground operations tasks. The resulting system will increase the inspection and task outcome verification capabilities of these systems, thus increasing the autonomous behavior of deployed robot systems on Earth and on other planets and moons.

Depicted in FIG. 1, Generative Adversarial Networks (GANs) are a machine vision technique that trains an artificial neural network to generate realistic members of a domain. Originally, these techniques targeted generating images, but they have since expanded to other domains. A GAN comprises two components: a discriminator 1200 and generator 1100. The discriminator is trained on labeled data 1300 to determine membership in the domain (for example, to determine whether an image contains a certain object or not) while the generator attempts to create members of the domain. Through training via a zero-sum game with the discriminator, the generator learns to map inputs to the targeted domain (for example, generate an image containing the target object from random noise). Note that such a GAN generator does not directly consume images, but rather generates a representative image provided some embedding.

GANs have been used for mobile robotics in GONet to determine traversability by training a GAN to generate images from input by only training on positive (traversable) data. This forces the GAN to map input images onto the manifold that contains only traversable images, regardless of the actual input. When deployed, a GAN maps the live camera feed/images to the “traversable” domain. A similarity check then compares the generated image with the input. If the two images diverge, then the image represented a non-traversable image that had been mapped to the traversable manifold, while if the two images were similar the GAN did not need to alter the image significantly to make it a member of the target class and was thus safe to traverse through. Training only on positive class members (only on traversable images) minimizes the amount of training data required, while still generalizing to novel environments.

GANs have become a standard technique available in popular Convolutional Neural Network libraries including TensorFlow and PyTorch.

CRAFTSMAN is a robot command and control framework built around a shared autonomy or human-in-the-loop control paradigm. Shared autonomy denotes a mid-point in the spectrum of robot control, with full teleoperation on one end, and fully autonomous systems on the other. This paradigm allows the operator to define high-level decisions (such as what whole-body skill to execute), while leaving low-level joint control to the robot. Conversely, for tasks that may seem “un-automatable” by traditional robotic systems integrators, shared autonomy can leverage the human operator to handle unforeseen errors brought upon by uncertainty present in unstructured environments, in sensing, and in decision-making. Such an architecture reduces cognitive load on the operator at run-time, can speed up overall execution, and can facilitate rapid deployment of automation. Furthermore, shared autonomy platforms like CRAFTSMAN can slide between fully autonomous modes (when uncertainty is reduced) or fully teleoperated modes (in pathological or emergency scenarios).

CRAFTSMAN is also designed to be hardware agnostic and was developed to provide an easy-to-configure and easy-to-use tool suite for both expert and non-expert developers. It provides advanced kinematics, obstacle-free finger/tool-tip planning, navigation planning, and motion-generation algorithms for both configuration and Cartesian spaces. The current software implementation uses libraries from the Robot Operating System (ROS) ecosystem, including inter-process messaging and 30 visualization tools. The application programming interface (API) also supports execution of the resulting plans on ROS-compatible robot hardware and simulation interoperability. CRAFTSMAN also provides an API for specifying Cartesian goals and requirements-either by teleoperation (through ROS's RViz 30 interaction environment) or by robot applications defined by an Affordance Template.

The Affordance Template specification is a task description language that provides robot-independent definitions for tasks that can be used in a variety of contexts on different robot platforms. Affordance Templates (ATs) allow a programmer to specify sequences of navigation, sensor, and end-effector waypoints represented in the coordinate systems of environmental objects as shown in FIG. 3. A digital twin consisting of an avatar of the robot, the robot's projected sensory data, and virtual overlays of both the objects and the task-specific waypoints can be visualized and (in the case of overlays and waypoints) adjusted in a 3D interactive environment. This digital twin also provides the operator with system state and previews of plans for verification if desired. Waypoints can include conditioning information such as the style of motion to prefer (e.g., straight-line versus joint motion) and can specify attached objects so that grasped and modeled objects will be accounted for automatically when generating collision-free plans. Recent work has investigated encoding inspection and multi-agent tasks in Affordance Templates.

The CRAFTSMAN suite has been deployed in a variety of applications, including: various proof-of-concept flexible manufacturing cells (using a variety of Motoman, ABB, and Denso robots) and one 24/7 high-volume production cell for a tier-one automotive parts supplier, the 5-armed RoboMantis platform developed by Motiv Space Systems, the Valkyrie bipedal humanoid at NASA Johnson Space Center, a custom dual-armed mobile manipulator testbed, and various custom and industrial robot simulations for NASA, U.S. Air Force, and others. Similarly, many of the individual components of CRAFTSMAN were initially deployed on the Boston Dynamic Atlas humanoid during the 2015 DARPA Robotics Challenge Finals.

Although this disclosure addresses a number of specific use cases, error/fault/anomaly detection is critical more broadly to industrial and other processes to detect deviations from acceptable outcomes and prevent potentially dangerous events from occurring. State of the art neural network (NN) error detection techniques require vast amounts of positive and negative training data to detect such errors. This requirement precludes the deployment of such tools in domains where errors rarely occur, are dangerous, or may be unknown as the required number of training examples cannot be obtained.

### SUMMARY

An exemplary GANDER system approach relies on a generative model that is built on a corpus of only positive outcomes. At run-time, this generative model maps input images to the learned positive manifold of task outcomes. The resulting differences between inputs and reconstructions can then be used to detect off-nominal behavior. Leveraging a generative model in such a way simplifies data requirements for training and potentially expands the deployment and adoption of automated error detection systems.

GANDER can enable error detection in areas that automated tools were previously inaccessible due to data requirements. It presents a potentially large return on investment as it can provide a second set of eyes for industrial processes, alerting operators if off-nominal behaviors or outcomes have emerged.

As discussed above, an existing supervisory control suite, CRAFTSMAN, addresses many of the critical needs specified by NASA HEOMD. The Affordance Templates task specification allows rapid creation, prototyping, and deployment of autonomous and semi-autonomous control applications for robotic IM&R needs. However, this control suite lacks robust error detection and autonomous inspection capabilities. Through the proposed GANDER approach, integrated machine vision tools (GANs) will be used to label erroneous execution and task outcomes, increasing the autonomous capabilities of the CRAFTSMAN software suite. Generative Adversarial Networks (GANs) are a machine vision technique that trains an artificial neural network to generate realistic members of a domain. As stated above, these techniques originally targeted generating images but have since expanded to other domains. Notably, GANs for mobile robotics in GONet have been used to determine traversability by training a GAN to generate images from input by only training on positive (traversable) data. By training only on positive class members (only on traversable images) the amount of training data required is minimized while still generalizing to novel environments.

A high-level block diagram for a GANDER system is shown in FIG. 4. A key insight is that existing control frameworks can generate extensive training data from simulation using Affordance Templates. This data could include trajectories, start and end states of the robot, or target object states. GANs trained on these domains would be able to detect error in execution (divergence from a planned trajectory) or error in task outcome (divergence in target object state) leveraging a network structure.

An exemplary GANDER system relies on mapping input images of a trained task to the manifold that contains only positive task outcomes. Images from successful task executions will therefore be largely unchanged, while images from a failed task will change significantly. Training a classifier to subsequently detect this difference enables on-line fault detection using feed-forward (or possibly recurrent) networks. The GANDER system may be developed using a variational autoencoder generative adversarial network (VAEGAN) architecture. The VAEGAN approach provided a principled means of encoding and mapping the input images to the positive manifold. Two classifiers, a “snap-shot” classifier using a feed-forward network and a “sequence” classifier using a recurrent network can be used in such an exemplary system. For purposes of this disclosure, data contained herein was collected from exemplary systems in accordance with various embodiments of this disclosure evaluated on two simulated test domains: a tabletop manipulation task and a lunar maintenance task.

As will be shown in greater detail below, in these two tasks, an exemplary GANDER system was able to correctly identify off-nominal behavior with 92.60% and 91.65% accuracy. Ablation studies were also performed to quantify the amount of data ultimately needed for such an approach to succeed. Additionally, comparisons to other state-of-the-art techniques were performed.

### DESCRIPTION OF THE DRAWINGS

For a detailed description of various, non-limiting embodiments of this disclosure, reference may be made to the following drawings.

FIG. 1 depicts the fundamental concept of a generative adversarial network. FIG. 1A depicts a discriminator trained on a large corpus of data. FIG. 1B depicts a generator trained to create novel images from the same domain.

FIG. 2 depicts GONet architecture. FIG. 2A depicts basic architecture that feeds an input image to a GAN which maps it to a traversable manifold. FIG. 2B depicts an extension from the basic architecture to ensure temporal continuity in a series of images through use of a long short-term memory (LSTM) unit.

FIG. 3 depicts an exemplary wheel turning affordance template (AT) as used with the NASA Valkyrie humanoid. FIG. 3A depicts a two-handed wheel-turning template. The virtual wheel object is shown along with ordered end-effector waypoints for both robot hands. FIG. 3B depicts views of a 3D environment where an operator can add the wheel-turning AT. FIG. 3C depicts the Valkyrie robot moving its end-effectors through AT waypoints to successfully turn the wheel.

FIG. 4 depicts a high level system diagram of a generative adversarial network for detecting erroneous results (GANDER) system in accordance with various embodiments of the present disclosure. Run-time images \tilde{x} are fed into an encoder to map to a latent representation z. This latent representation is then mapped to the positive manifold through a reconstruction yielding \tilde{x}. The original input and reconstruction are then fed into a classifier. If the input x and reconstruction \tilde{x} diverge significantly, the input did not originally belong to the manifold, indicating that the input was capturing off-nominal behavior.

FIG. 5 depicts a manipulation task in accordance with various embodiments of the present disclosure. FIG. 5A depicts a tabletop manipulation task environment. FIG. 5B depicts a successful task completion. FIG. 5C depicts a task failure.

FIG. 6 depicts a lunar maintenance task in accordance with various embodiments of the present disclosure. FIG. 6A depicts a lunar maintenance task environment. FIG. 6B depicts a successful task completion. FIG. 6C depicts a task failure.

FIG. 7 depicts a high level variational autoencoder generative adversarial network (VAEGAN) structure in accordance with various embodiments of the present disclosure. The model combines a VAE (labeled AE) and a GAN to create a robust encoder based on the feature representations earned by the GAN discriminator. This approach leads to an encoder that is more representative of the target domain.

FIG. 8 depicts failure modes of two tasks in accordance with various embodiments of the present disclosure. FIG. 8A depicts failure modes of a lunar maintenance task in which the discriminator progressed too fast for the generator to receive any meaningful signal. FIG. 8B depicts failure modes of a tabletop manipulation task in which the generator only learned to generate a small subset of the domain.

FIG. 9 depicts a GANDER system diagram with expanded classifier block for the fully connected (FC) classifier in accordance with various embodiments of the present disclosure.

FIG. 10 depicts a GANDER system diagram with expanded classifier block for the LSTM classifier in accordance with various embodiments of the present disclosure.

FIG. 11 depicts performance of the two classifiers (error per time step) in the test dataset for Task 1. FIG. 11A depicts performance for the FC classifier. Although statistically performing well, outliers exhibit high entropy. This variation is due to the isolated snapshot nature of the classifier—predicts can vary greatly between timesteps. FIG. 11B depicts performance of the LSTM classifier. The LSTM is able to incorporate temporal information missing from the VAEGAN and smooths the results. Note that the LSTM smoothing cuts both ways as errors are also propagated throughout with greater consistency (seen from lack of outliers with intermediate errors).

FIG. 12 depicts receiver operating characteristic (ROC) curves for the classification approaches. These capture the classifier's recall as a function of fall-out. The dashed line on the diagonal represents a random classifier. Curves that hug the upper left of the plot are preferable as they correctly label positives without overestimating false positives—as such the area under the curve (AUC) is a rough summary measure. FIGS. 12A and 12B demonstrate that both approaches outperform a random classifier and have high recall with low fall-out.

FIG. 13 depicts a rollout of a successful pick trajectory. The analysis indicated that although both classification approaches suffered failures, the FC labeling within trajectories tended to have higher entropy—predictions could shift dramatically from one time stamp to the next. The prediction errors of the FC and LSTM for the rollout trajectory illustrate this.

FIG. 14 depicts FC classifier “abort” behavior in Task 1. FIG. 14A depicts such behavior over a true positive trajectory. FIG. 14B depicts such behavior over a true negative trajectory. For ease of analysis, trajectories longer than 14 timesteps long were truncated to 14 while trajectories less than 14 timesteps were processed only up to the max timestep. A hit at a particular timestep indicates the point that P(success)<α, where a is a specified threshold. When this occurs, an abort would be triggered, and the robot would stop executing the trajectory. A perfect classification/abort system would have no FN (all trajectories in “Miss”) in FIG. 14A and catch all TN (no trajectories “Miss”) in FIG. 14B.

FIG. 15 depicts LSTM classifier “abort” behavior in Task 1. FIG. 15A depicts such behavior over a true positive trajectory. FIG. 15B depicts such behavior over a true negative trajectory. For ease of analysis, trajectories longer than 14 timesteps long were truncated to 14 while trajectories less than 14 timesteps were processed only up to the max timestep. A hit at a particular timestep indicates the point that P(success)<α, where a is a specified threshold. When this occurs, an abort would be triggered, and the robot would stop executing the trajectory. A perfect classification/abort system would have no FN (all trajectories in “Miss”) in FIG. 15A and catch all TN (no trajectories “Miss”) in FIG. 15B.

FIG. 16 depicts GANDER system prediction errors over the Task 2 test trajectory timesteps. FIG. 16A depicts FC classifier prediction error. FIG. 16B depicts LSTM prediction error.

FIG. 17 depicts FC classifier “abort” behavior in Task 2. FIG. 17A depicts such behavior over a true positive trajectory. FIG. 17B depicts such behavior over a true negative trajectory. For ease of analysis, trajectories longer than 28 timesteps long were truncated to 28 while trajectories less than 28 timesteps were processed only up to the max timestep. A hit at a particular timestep indicates the point that P(success)<α, where a is a specified threshold. When this occurs, an abort would be triggered, and the robot would stop executing the trajectory. A perfect classification/abort system would have no FN (all trajectories in “Miss”) in FIG. 17A and catch all TN (no trajectories “Miss”) in FIG. 17B.

FIG. 18 depicts LSTM classifier “abort” behavior in Task 2. FIG. 18A depicts such behavior over a true positive trajectory. FIG. 18B depicts such behavior over a true negative trajectory. For ease of analysis, trajectories longer than 28 timesteps long were truncated to 28 while trajectories less than 28 timesteps were processed only up to the max timestep. A hit at a particular timestep indicates the point that P(success)<α, where a is a specified threshold. When this occurs, an abort would be triggered, and the robot would stop executing the trajectory. A perfect classification/abort system would have no FN (all trajectories in “Miss”) in FIG. 18A and catch all TN (no trajectories “Miss”) in FIG. 18B.

FIG. 19 depicts GANDER ROC curves. FIG. 19A depicts curves for a fully-connected model on Task 2. FIG. 19B depicts curves for an LSTM ablated model on Task 2.

FIG. 20 depicts FC classifier “abort” behavior in Task 2 for various ablated models.

FIG. 20A depicts such behavior over a true positive trajectory. FIG. 20B depicts such behavior over a true negative trajectory. For ease of analysis, trajectories longer than 28 timesteps long were truncated to 28 while trajectories less than 28 timesteps were processed only up to the max timestep. A hit at a particular timestep indicates the point that P(success)<0.05 for each ablated model. When this occurs, an abort would be triggered, and the robot would stop executing the trajectory. A perfect classification/abort system would have no FN (all trajectories in “Miss”) in FIG. 20A and catch all TN (no trajectories “Miss”) in FIG. 20B.

FIG. 21 depicts LSTM classifier “abort” behavior in Task 2 for various ablated models.

FIG. 21A depicts such behavior over a true positive trajectory. FIG. 21B depicts such behavior over a true negative trajectory. For ease of analysis, trajectories longer than 28 timesteps long were truncated to 28 while trajectories less than 28 timesteps were processed only up to the max timestep. A hit at a particular timestep indicates the point that P(success)<0.05 for each ablated model. When this occurs, an abort would be triggered, and the robot would stop executing the trajectory. A perfect classification/abort system would have no FN (all trajectories in “Miss”) in FIG. 21A and catch all TN (no trajectories “Miss”) in FIG. 21B.

FIG. 22 depicts prediction error over all test trajectories for the baseline FC classifier trained on extracted convolutional features.

FIG. 23 depicts prediction error over all test trajectories for the baseline FC classifier trained directly on the annotated image set.

FIG. 24 depicts prediction error over all test trajectories for the baseline VAE front-end FC classifier trained directly on the annotated image set.

FIG. 25 depicts prediction error over all test trajectories for the baseline VAE front-end LSTM classifier trained directly on the annotated image set.

FIG. 26 depicts classifier “abort” behavior in Task 2 for various GANDER and baseline models. FIG. 26A depicts such behavior over a true positive trajectory. FIG. 26B depicts such behavior over a true negative trajectory. For ease of analysis, trajectories longer than 28 timesteps long were truncated to 28 while trajectories less than 28 timesteps were processed only up to the max timestep. A hit at a particular timestep indicates the point that P(success)<0.10 for each ablated model. When this occurs, an abort would be triggered, and the robot would stop executing the trajectory. A perfect classification/abort system would have no FN (all trajectories in “Miss”) in FIG. 26A and catch all TN (no trajectories “Miss”) in FIG. 26B.

FIG. 27 depicts a low-level VAEGAN network structure. Each row describes a layer in the respective network architecture. For example, (4×4)×64, ↓, S/BNorm, ReLU refers to a convolutional layer with 64-(4×) kernels, that down-samples the previous layer, and applies (S)pectral and (B)atch normalization before using a ReLU activiation function. Additionally, FC references a (F)ully-(C)onnected layer and DO references (D)rop (O)ut layers.

FIG. 28 depicts classifier accuracy and mean prediction error over the test images of Task 1.

FIG. 29 depicts summary abort measures for TP and TN trajectories in Task 1 over various thresholds a. The system marks an abort when P(success)<α. A perfect classifier would trigger no aborts on TP trajectories and trigger aborts on all TN trajectories.

FIG. 30 depicts classifier accuracy for binary label for success/failure and prediction error over 5 trained models for the test set images of Task 2.

FIG. 31 depicts the impact of positive manifold training dataset size on reconstruction quality in terms of pixel-level errors for images on the positive manifold for Task 2. Each model was trained with the same set of hyperparameters and evaluated on the same test set (sampled 10% of full dataset).

FIG. 32 depicts the impact of positive manifold training dataset size on reconstruction quality in terms of pixel-level errors for images not on the positive manifold for Task 2. Each model was trained with the same set of hyperparameters and evaluated on the same test set (sampled 10% of full dataset).

FIG. 33 depicts a performance comparison of classifier performance subject to training set ablations using a frozen VAEGAN trained on the entire dataset for Task 2.

FIG. 34 depicts summary abort measures for TP and TN trajectories in Task 2 for GANDER models trained on ablation annotated datasets For each approach, 5 models were trained from scratch using the specified ablation of the annotated training dataset. A frozen VAEGAN trained on the entire manifold dataset was used for each. The system marks an abort when P(success)<0.05. A perfect classifier would trigger no aborts on TP trajectories and trigger aborts on all TN trajectories.

FIG. 35 depicts a performance comparison of image classification accuracy and prediction of GANDER against baselines. Each approach was trained 5 times on the full Task 2 training dataset and evaluated on a withheld fixed test split evenly across positive and negative instances. Network hyperparameters were held constant across the models.

FIG. 36 depicts summary abort measures for TP and TN trajectories in Task 2 for GANDER and baseline models trained on ablation annotated datasets For each approach, 5 models were trained from scratch using the entire annotated training dataset. A frozen VAEGAN trained on the entire manifold dataset was used for each. The system marks an abort when P(success)<0.05. A perfect classifier would trigger no aborts on TP trajectories and trigger aborts on all TN trajectories.

FIG. 37 depicts elements of the PRIDE system. FIG. 37A is a recreated screen capture of Pride Author, the procedure authoring component of PRIDE, with key components emphasized. Procedure authors can build procedures with reusable drag-and-drop elements.

FIG. 37B is a recreated screen capture of Pride View, the interface to enable monitoring and execution of procedures, with key components emphasized. Crew members can monitor automated procedures and can intervene if needed.

FIG. 38 depicts a GANDER system operating within the context of Task 2. The robot is performing a hose mating task on the lunar surface. The snapshots between t₀ and t₁₈ depict a failed execution. Small differences between input (x) and reconstruction (\tilde{x}) indicate nominal behavior (t₀->t₁) while off-nominal behavior generates large differences (t₁₈) allowing GANDER to detect the failure and abort further robot motions.

FIG. 39 depicts a system integrating GANDER and PRIDE (or other similar robotic control platform) in accordance with various embodiments of the present disclosure. As depicted, a user submits an image of task progress (in this case, assembling a robot) via the control platform which then causes a trained GANDER model to evaluate the image. The GANDER model maps the submitted image to its learned positive manifold to detect a disparity and reports its findings back to the control platform. In the event of a failure (as depicted), the control platform may then alert the user to such failure or trigger procedures to address the fault.

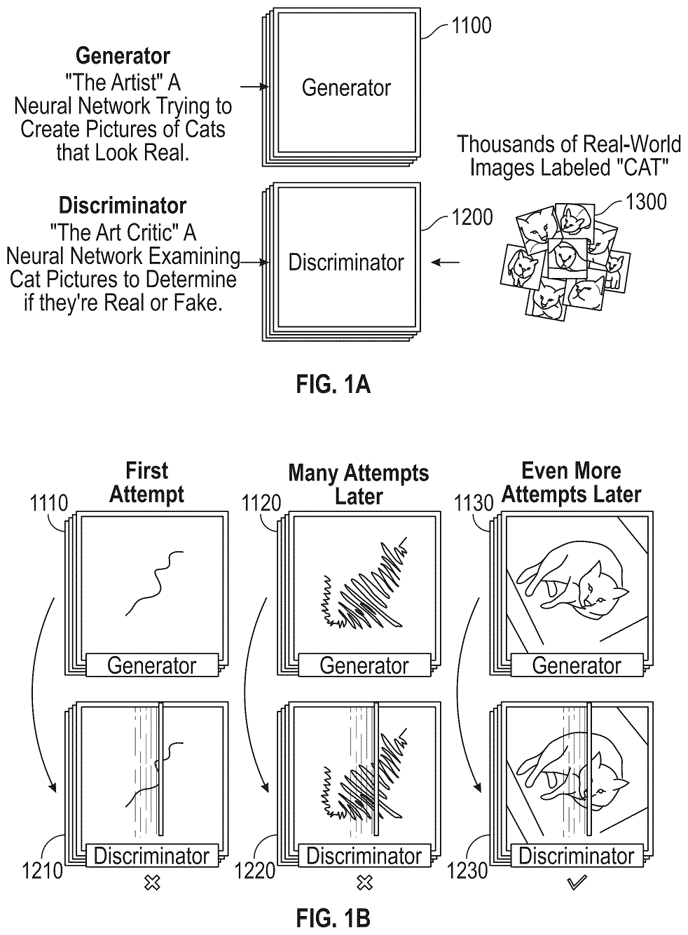

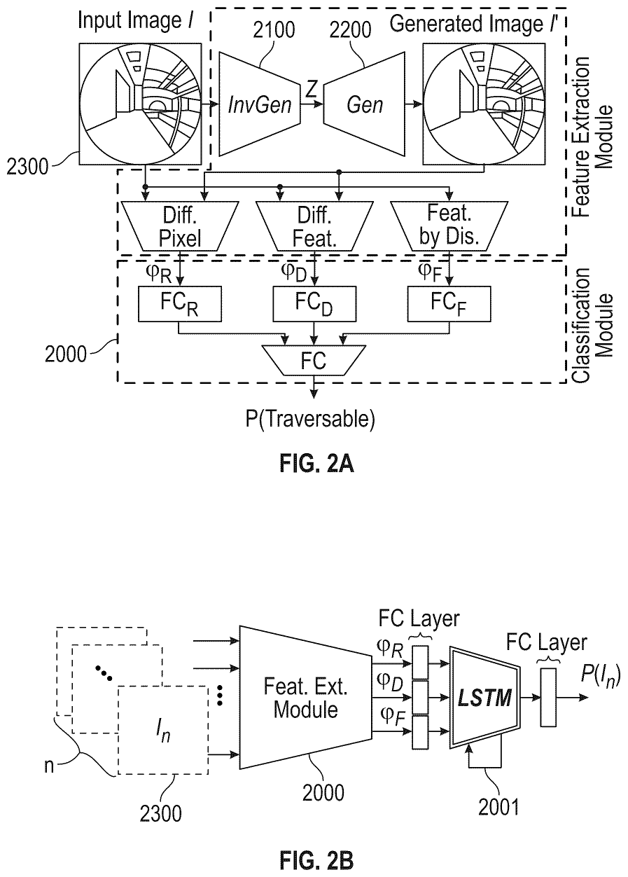

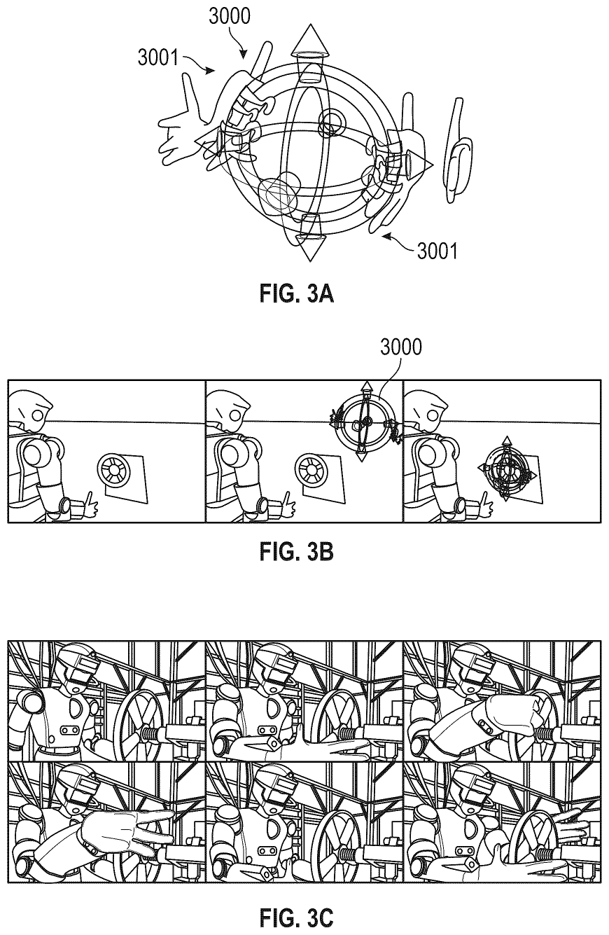

### DETAILED DESCRIPTION

The following discussion is directed to various embodiments of the present disclosure. The embodiments disclosed should not be interpreted or otherwise used as limiting the scope of the disclosure. One skilled in the art will understand that the following description has broad application, and the discussion of any embodiment is meant only to be exemplary of that embodiment, and not intended to suggest that the scope of the disclosure, including the claims, is limited to such an embodiment.

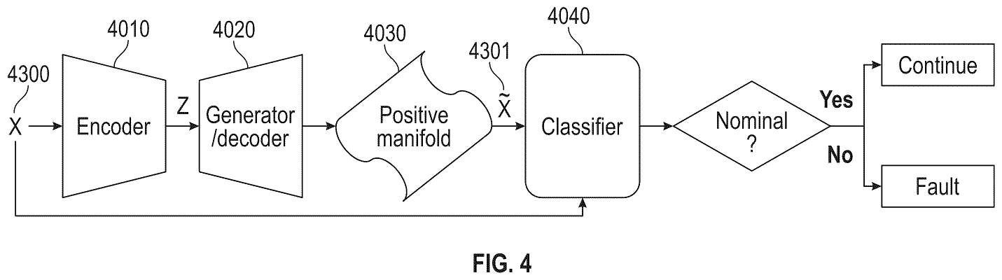

An exemplary GANDER system in accordance with this disclosure such as that generally depicted in FIG. 4 may comprise a computational system including an encoder 4010, a generator/decoder 4020, a manifold 4030, a classifier 4040, and at least one data element 4300. The arrangement, configuration, function, and use of the structures (and any substructures thereof) are described below, and these structures may be implemented on conventionally known computational systems such as those used in the command and control of robotics.

In order to train and validate an exemplary GANDER system, datasets may be developed into discrete tasks such as two different manipulation tasks. An exemplary GANDER system has been trained and validated with respect to a tabletop manipulation task involving grasping a target object and a lunar maintenance task involving attaching a hose to a standpipe. The tasks were encoded as Affordance Templates and performed in custom Gazebo simulation environments. Both tasks leveraged a simulated Zebra Fetch robot. This robot was selected due to reliable performance (specifically with respect to manipulation) in Gazebo simulation. RGB images were collected from the robot's head-mounted sensor at 3 Hz and resized to 128×128 to reduce the dataset size and ease training.

Data collection relied on Gazebo's physics engine for contact dynamics (as no objects were rigidly attached behind the scenes) in order to allow for natural in-hand movement of manipulated objects. The only simulation parameters that were modified were target objects' friction properties to increase the “stickiness” of objects. Additionally, torsional friction was enabled on the target models. This was determined to have a large impact because the Fetch robot's contact points in simulation resolve as point contacts. Without torsional friction, which is disabled by default, any mass on either side of the contact location induces a moment, causing the grasped object to rotate in hand. Although this did not impact Task 1 as the target object was oriented such that no such moment was created during grasping, to generate stable grasps in Task 2 torsional friction was required (and thus enabled) when collecting images for the manifold 4030 (in this embodiment, positive examples to develop a positive manifold) and disabled when collecting negative examples (for training the classifier 4040 and testing/validation purposes). Disabling when collecting negative examples simulates in-hand slippage when grasping.

Two minor additions were added to CRAFTSMAN feedback messages during planning and execution to facilitate data collection. The first was a flag to indicate that execution had begun when autonomously planning and executing motions. This reduced the size of training data to capture images only during execution. The second addition was to provide feedback on the step of the AT that was being executed to. This additional information facilitated annotating collected data for possible later use or reference.

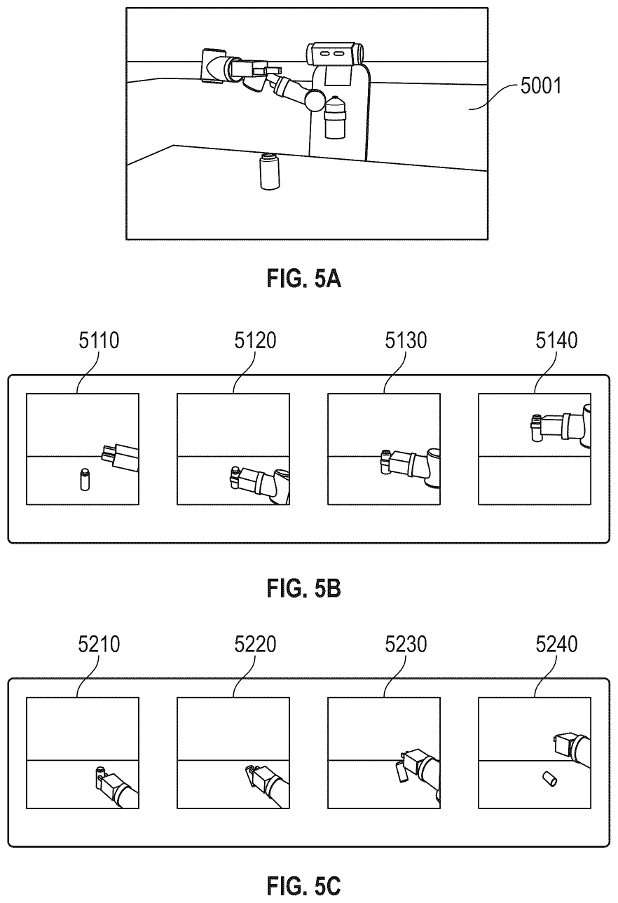

The tabletop manipulation task required a robot to acquire and lift a target object (a soda can) from a table top. The simulation environment and snapshots of execution from the robot's perspective are shown in FIG. 5. Snapshots 5110, 5120, 5130, and 5140 were taken from successful completion of the task during data collection captured by the robot's onboard sensors. Snapshots 5210, 5220, 5230, and 5240 were taken from a failed task execution during data collection capture by the robot's onboard sensors. This task contains many of the foundational attributes of interaction-based tasks, such as acquiring and re-positioning target objects. This task also provides a straightforward and ideal setting for exploring domain transfer. By changing the target object to be acquired, we can begin to explore how well a GANDER system will detect failures with novel objects.

Data was autonomously collected through the use of a finite state machine configured to reset the simulation, randomly position the can within a target region on the table, align the task AT using this position, and then plan and execute motions to complete the task. Images from configurations that were unreachable from the initial robot state or that failed to lift the target object to the goal were rejected. Data was collected from 13830 runs, ultimately yielding 208526 images. From this overall collection, 140000 positive images were randomly selected to be used for training the positive manifold 4030 and were grouped into training, validation, and test sets following an 80/10/10 split.

To train the classifier 4040, a “noisy” version of our initial finite state machine was leveraged to collect a set of failing tasks. This noisy finite state machine added random noise to the AT placement. The addition of such noise results in misalignment between the target object and the AT goals, often resulting in unintended collisions. Data collection under these conditions resulted in an additional 1228 “negative” trials consisting of 15218 images. The full, annotated dataset for training the classifier was then generated by sampling 1200 trials from this negative set, along with an equal number of positive trials, and once again splitting the collection into a 80/10/10 train/validation/test split. This resulted in a total of 27212, 2721, and 2639 images in each set respectively. During sequential training, trajectories are clipped or padded to a sequence length of 14 images.

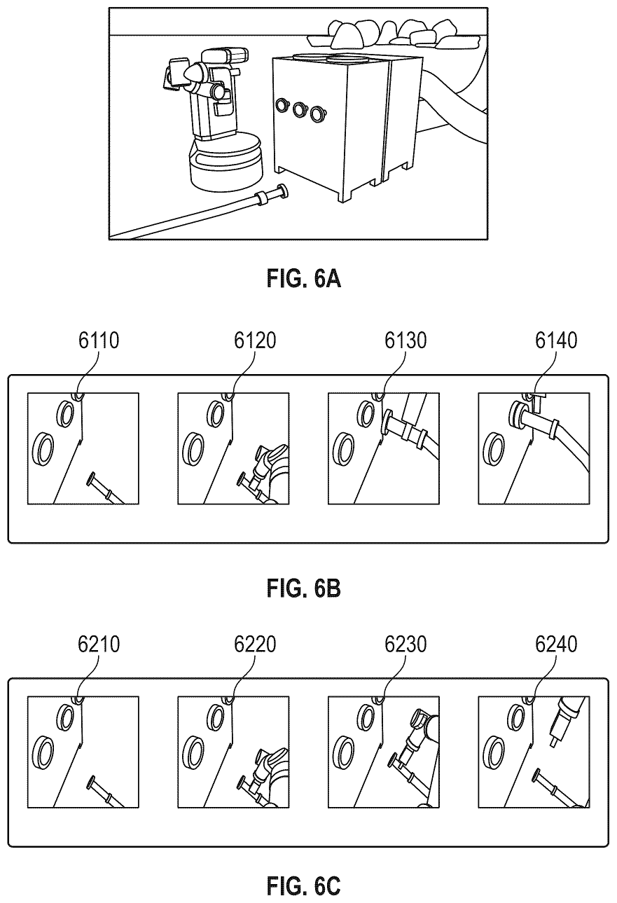

The lunar maintenance task required a robot to acquire and attach a hose to a standpipe—an analog of attaching life support or power lines between habitat modules. The simulation environment and snapshots of execution from the robot's perspective are shown in FIG. 6. Snapshots 6110, 6120, 6130, and 6140 were taken from successful completion of the task during data collection captured by the robot's onboard sensors. Snapshots 6210, 6220, 6230, and 6240 were taken from a failed task execution during data collection capture by the robot's onboard sensors. Similar to task 1, to automate data collection, finite state machines were created that managed the simulation and object locations. For testing here, the start location was not modified. Instead, the “noise” in execution involved the contact dynamics between the hose and hand. In order to capture a set of in-hand slips, contact friction properties of the model were disabled when collecting negative examples for training the classifier. Positive task-execution data were collected from 4828 runs, ultimately yielding 140713 images. Similar to the previous task, for the training data, 140000 positive images were randomly sampled and used to create training, validation, and testing sets using an 80/10/10 split. Additionally, 2351 negative trajectories (63938 images) were collected and used to create annotated data for training the classifier in the same manner as the tabletop manipulation task, resulting in 58145, 5808, 5836 images in the training, validation, and test sets respectively. During sequential training, trajectories are clipped or padded to a sequence length of 28 images.

In exemplary GANDER systems, a VAEGAN network may be leveraged to provide the image-to-image mapping described herein. By itself, a GAN takes as input a latent vector representation z, z˜ N(0,1), and learns to generate representative images from that input. As such, in order to leverage GANs in image-to-image translation, a means to encode the input image into the latent space is necessary. To obtain this functionality in GONet, the GAN generator is inverted and re-trained in a secondary round of training to map the input image to the latent representation z using a loss function that optimizes accurate reconstructions of the input.

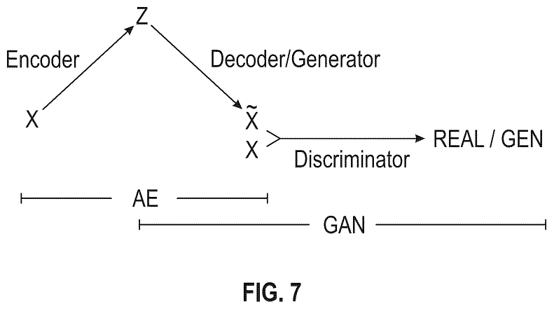

The VAEGAN network provides a more principled way of achieving similar functionality by combining a GAN and a variational autoencoder (VAE). A VAE is composed of an encoder that encodes input x to a latent representation z and a decoder that maps the latent representation z back to the input domain. Although a VAE can be used directly for image-to-image translation, the representation relies on a pixel-level error signal rather than a feature-level signal, resulting in blurry reconstructions. The VAEGAN approach addresses this shortcoming by combining a VAE and GAN network through collapsing the VAE decoder and the GAN generator as shown in FIG. 7. By collapsing the VAE decoder and GAN generator, the learned feature representations from the GAN discriminator can be used in the VAE reconstruction objective. This effectively forces the generator/decoder to learn using richer features from the GAN discriminator instead of using only pixel-level errors, leading to a decoder/generator that yields better reconstructions than a traditional VAE. The VAE encoder provides a principled means of embedding input images for the GAN generator. Additionally, since the training of a VAEGAN simultaneously trains the VAE and GAN, additional retraining steps as used by GONet are not required.

Specifically, the VAEGAN network optimizes a loss function L, shown in the first equation below, which trains a VAE and a GAN concurrently. This is achieved by combining a prior loss that encourages coverage and locality of the latent space (the second equation), a reconstruction loss that encourages reconstructions of the input from the latent space (third equation), and a GAN loss, which encourages generating outputs representative of the target domain that fool the discriminator (the fourth equation).

$$= {prior}_{} + + {GAN}_{}$$

$${prior}_{} = {D}_{KL} ( q ( z \vert x ) ‖ p ( z ) )$$

$$= - {E}_{q ( z \vert x )} [ log p ( {Dis}_{t} ( x ) \vert z ) ]$$

$${GAN}_{} = log ( Dis ( x ) ) + log ( Dis ( Gen ( z ) ) ) + log ( Dis ( Gen ( Enc ( x ) ) ) )$$

However, not all network parameters are updated with the combined loss and instead each network is updated via the following rules:

$$\text{?} {←}^{+} - \text{?} ( {prior}_{} + )$$

$$\text{?} {←}^{+} - ( γ - {GAN}_{} )$$

$$\text{?} {←}^{+} - \text{?} {GAN}_{}$$

$$\text{?} \text{indicates text missing or illegible when filed}$$

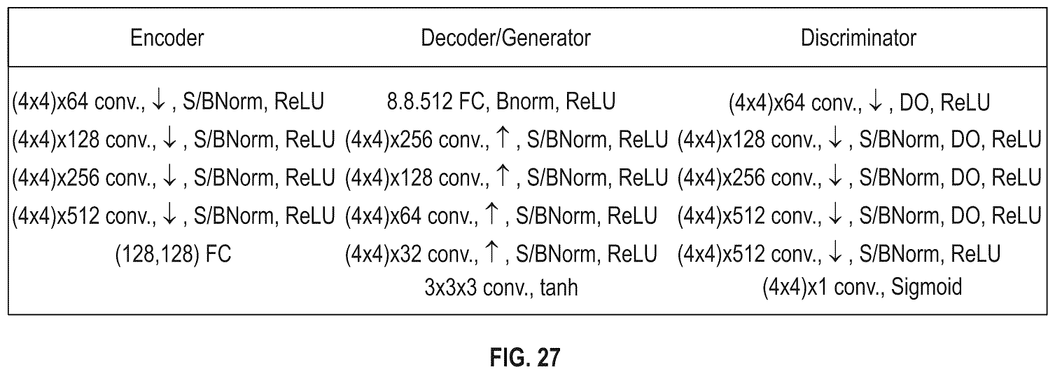

A more detailed view of the VAEGAN network architecture is shown in FIG. 27.

In addition to the VAEGAN loss and update rules above, a cyclic weighting of Lₚᵣᵢₒᵣ was introduced in order to emphasize either coverage and locality of the latent space or input reconstruction. Cycling this weighting helps avoid local minima during training. Random hyperparameter searches were performed to identify a promising parameterization for training the network. This search identified the relative learning rates of the VAE and GAN discriminator, along with the Lₚᵣᵢₒᵣ cycle length having the largest impact on performance.

Other image-to-image networks have taken similar approaches as the VAEGAN network to combine GAN-loss with an AE loss. In that work, the reconstruction loss includes a pixel-level loss in addition to the standard GAN loss for the generator/decoder only. In order to increase the reconstruction of the input “content”, a standard VAE pixel loss was added to the VAEGAN generator's loss with weighting λ. This addition helps guide the gradient in early training, where pixel-level differences will provide more guidance than discriminator features. This transforms the generator update in the sixth equation above to:

$${θ}_{gen} {←}^{+} - {∇}_{{θ}_{gen}} ( γ ( - λ {Eq}_{( z \vert x )} [ log p ( x \vert z ) ] ) - {GAN}_{} )$$

The remaining update rules (the fifth and seventh equations above) are unmodified.

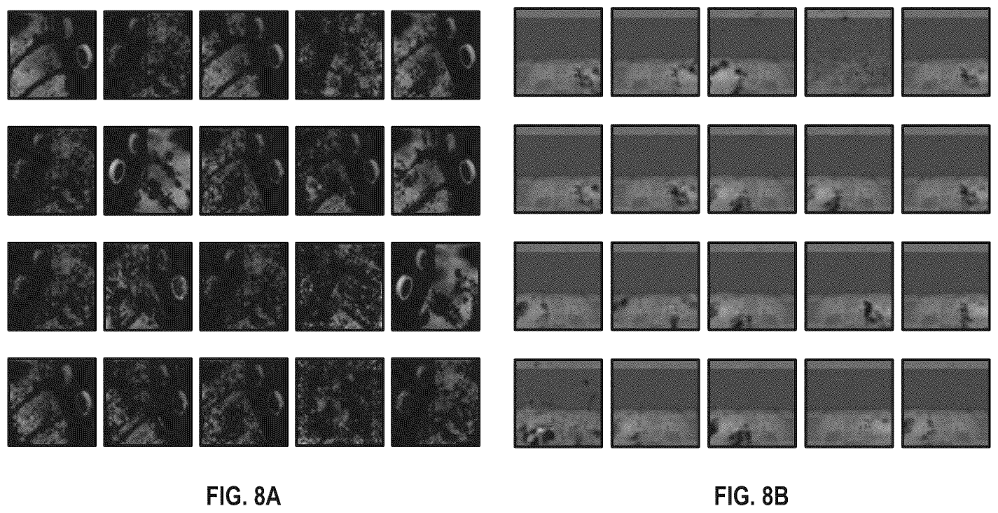

During training, several versions of mode collapse were encountered. These failure modes are inherent in adversarial approaches where two networks compete against each other. These failure modes arose when the discriminator learning progressed too fast for the generator to learn further or when the generator degenerated to map all images to a small subset of the domain. When these were encountered, training was restarted, albeit with a smaller learning rate. Examples of these mode collapses can be seen in FIG. 8.

Initial training results using the aforementioned loss terms yielded unstable performance. It was determined that the VAEGAN framework loss term accounts for “synthetic” data twice. Revisiting Equation 4, with terms relating to real data and the terms relating to synthetic data,

$${GAN}_{} = log ( Dis ( x ) ) + log ( Dis ( Gen ( z ) ) ) + log ( Dis ( Gen ( Enc ( x ) ) ) )$$

shows that the loss is weighting real and synthetic data unequally. In the VAEGAN approach, first synthetic term—the log-probability of fooling the discriminator—serves to regularize the latent space of the GAN prior by using a sample z drawn from the prior. The second synthetic term—the log-probability of the reconstruction fooling the discriminator—uses the learned encoding of the input. As the encoder is already regularizing the latent space, this effectively double dips as Enc(x)≈z. This double dipping is likely creating gradient issues during training. As such, the loss function was further modified to eliminate the first synthetic term altogether, yielding

$${GAN}_{} = log ( Dis ( x ) ) + log ( Dis ( Gen ( Enc ( x ) ) ) )$$

which equally weights the real and synthetic data when training the system. The resulting system proved much more stable in training.

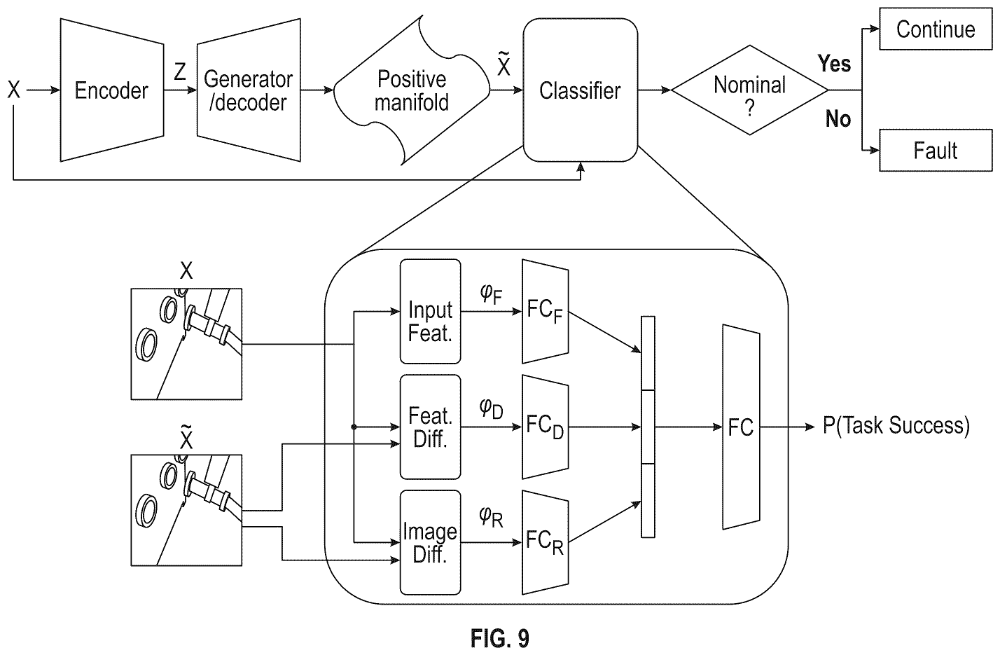

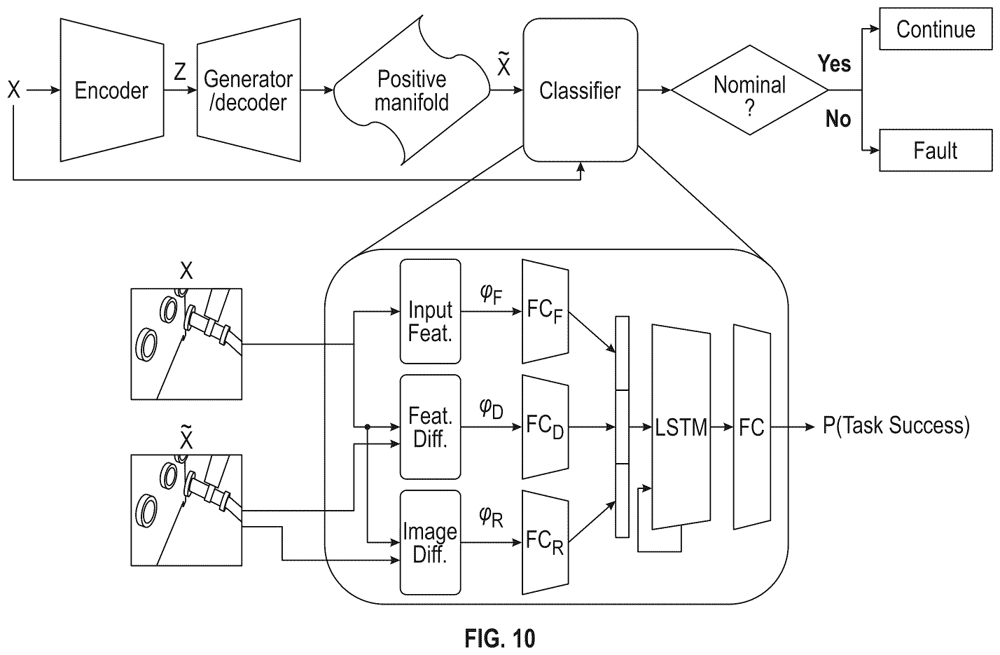

GANDER deals with streaming time-series data, so a recurrent approach, like long short-term memory (LSTM), is ideally suited to detect whether an input trajectory is evolving toward off-nominal behavior. However, a standard state of the art classifier—a fully connected (FC) classifier—may be used to determine if input images were nominal or not. When testing an exemplary GANDER system, this “snap-shot” classifier was initially used to provide a baseline performance that was contrasted with LSTM performance. Ideally, the LSTM should be able to detect “off-nominal” trajectories faster, allowing for earlier preemption of unsafe trajectories. Diagrams illustrating the two classifiers are shown in FIG. 9 for the FC classifier and in FIG. 10 for the LSTM classifier. Both approaches were fed features that were extracted from the input and reconstruction images.

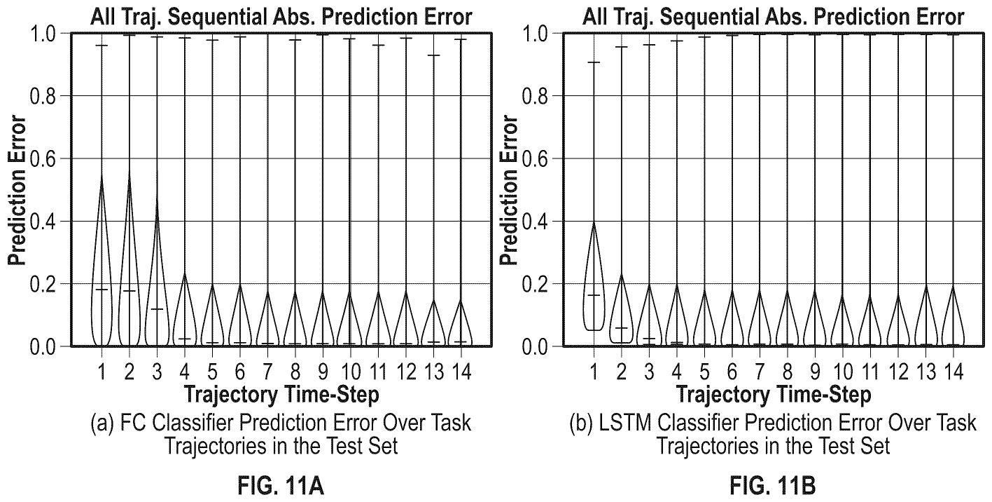

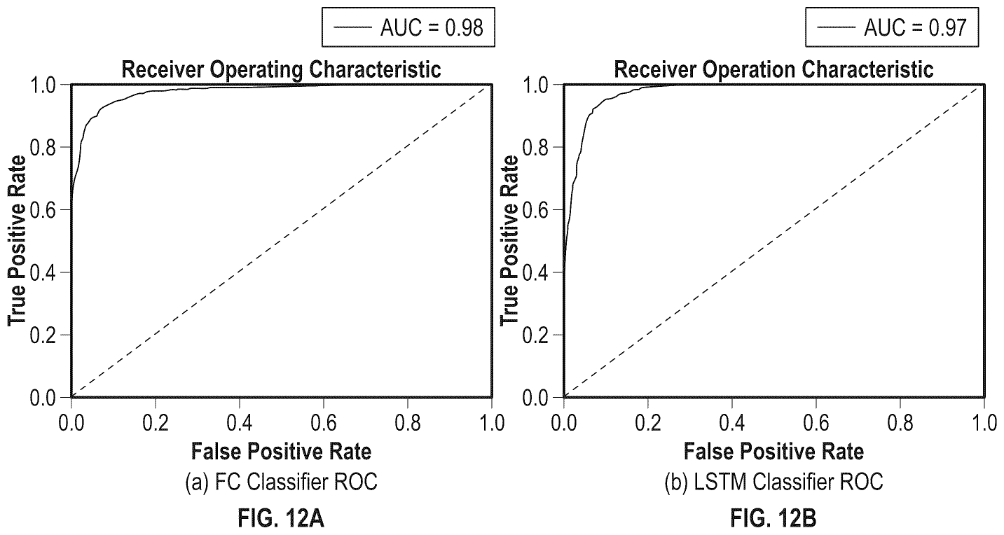

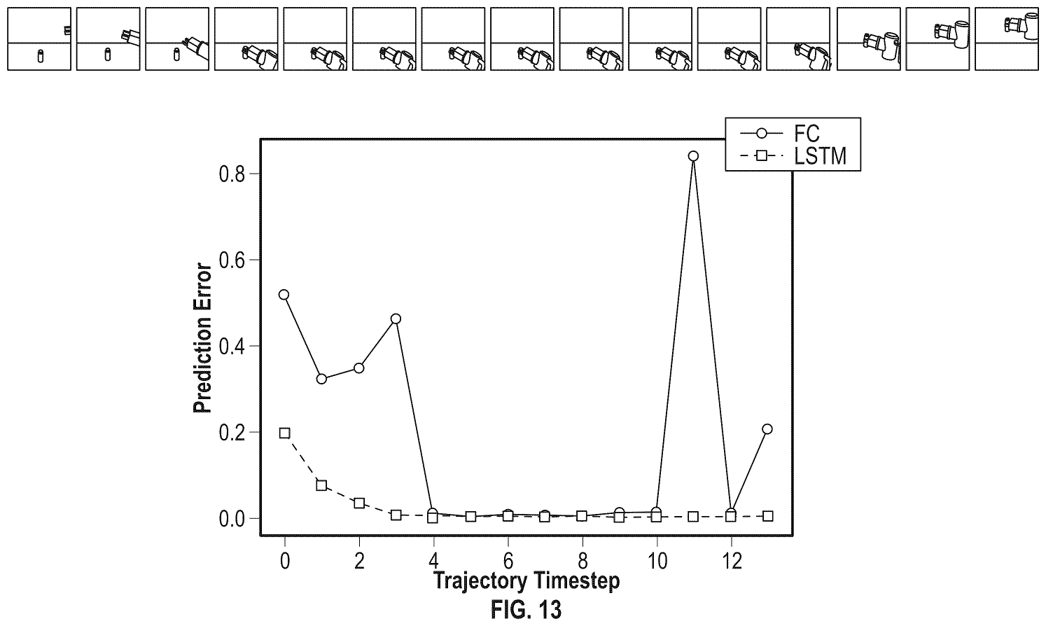

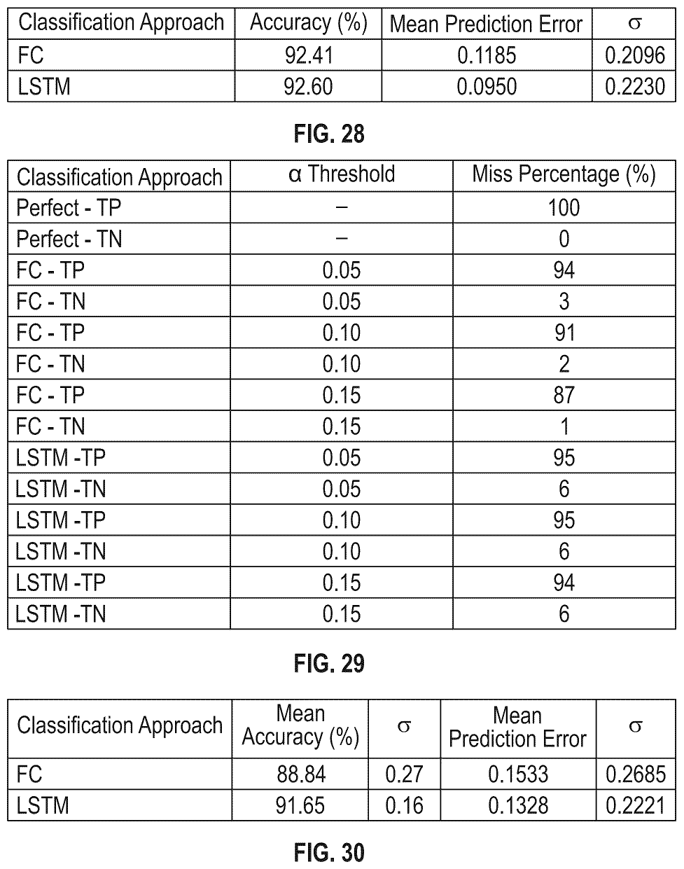

The overall per-image classification performance in Task 1 is enumerated in FIG. 28 along with the mean prediction error. This summary view fails to capture the performance of the GANDER system fully, as it does not capture behavior over a (streaming) input trajectory. The mean prediction error performance of the FC and LSTM classifiers over all Task 1 trajectories are shown in FIG. 11. This trajectory-level view indicates that both approaches are initially less certain/have higher prediction error, which is reduced within a few timesteps. This is expected, as the initial timestep images in a trajectory will be similar in both positive and negative instances. FIG. 12 contains receiver operating characteristic (ROG) curves for both the FC and LSTM classifiers on Task 1. These curves capture the classifier's recall as a function of fall-out. These results indicate that both classification approaches perform well, correctly labeling positive outcomes without overestimating false-positives. FIG. 13 demonstrates how the FC approach can produce predictions that vary greatly between timesteps while the LSTM can incorporate temporal data to smooth such variations.

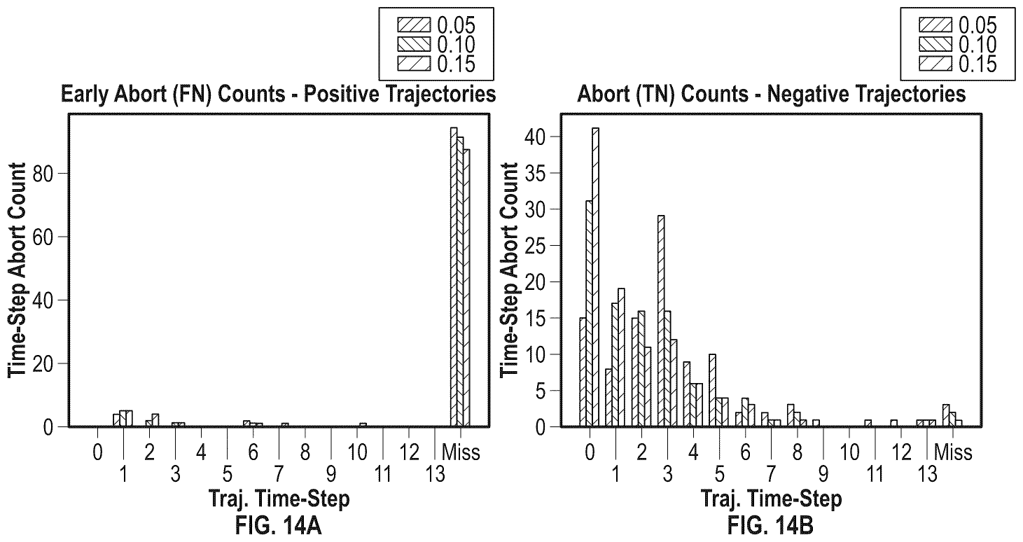

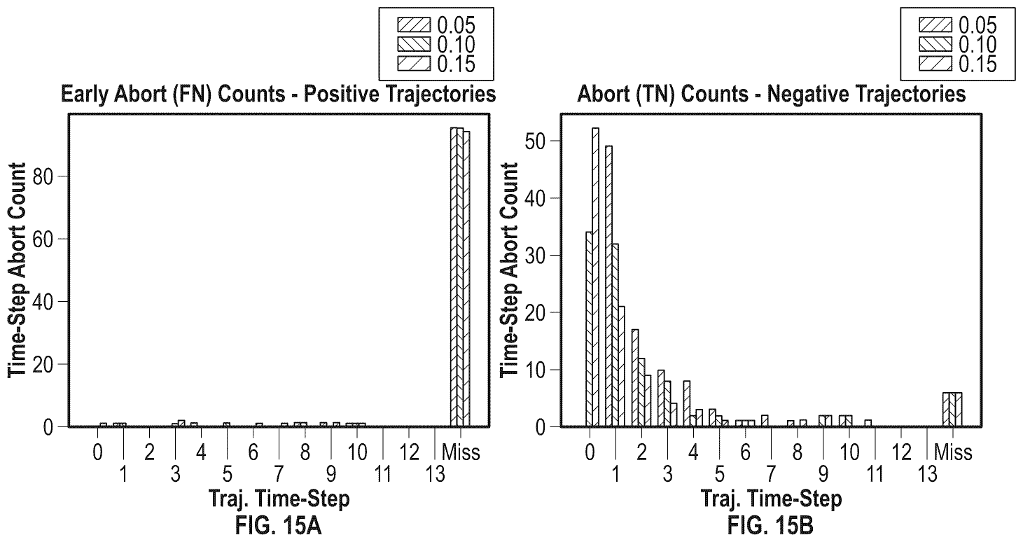

FIGS. 14 and 15 demonstrate the possible “abort” behavior enabled by an exemplary GANDER system. For these bar charts, all trajectories in the test set are iterated through, split evenly between true positives and true negatives. All trajectories were truncated to 14 timesteps for ease of analysis. Any trajectory<14 was analyzed up to the trajectory size. For each trajectory we then note at which point the P(success)<α, where a is an “abort” threshold specified in the plot legends. When this occurs, the robot stops executing the remaining trajectory. For true positive (TP) trajectories this corresponds to a false negative (FN), while for true negative (TN) trajectories this indicates a true negative. If a trajectory did not fall under the threshold it is binned under “Miss.” A perfect classifier would have no hits in the TP set (all trajectories would fall in “Miss”) and would detect all TN in the TN set (no trajectories would fall in “Miss”). GANDER catches the vast majority of failures while only inducing occasional false negatives. The plots indicate trade-offs between the two classifier approaches. The LSTM detects TN earlier in each trajectory and has higher TP miss rate, however the FC has a lower TN miss rate at the expense of lower TP miss rate. These data are summarized in FIG. 29, which displays the percentages of “Miss” trajectories over the test sets.

The subset of TN “misses” for each approach were investigated. Of note is that the FC and LSTM approaches missed trajectories that were truncated before the end of the trajectory. The LSTM additionally missed a small number of TN trajectories.

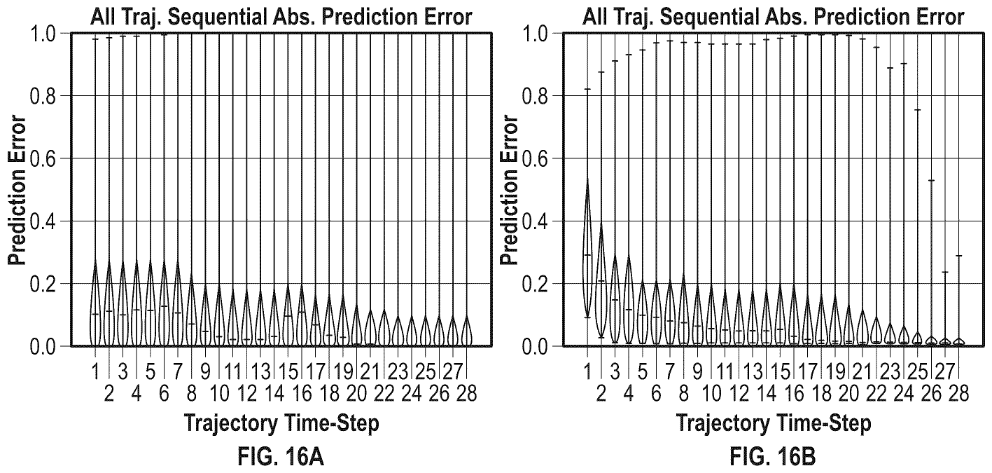

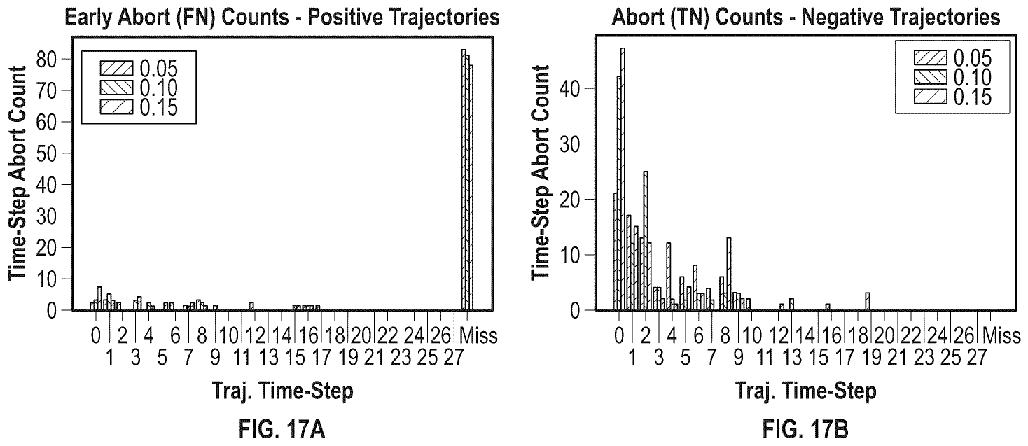

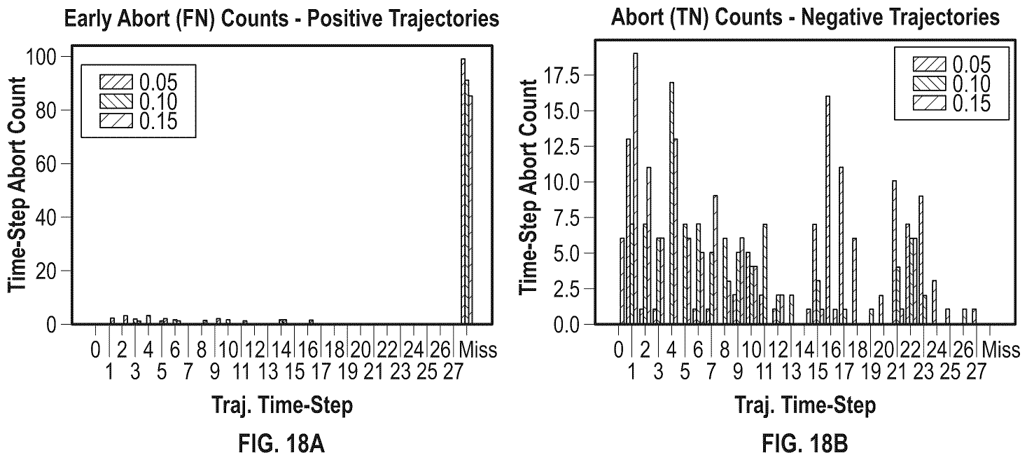

Overall prediction error and accuracy for Task 2 are shown in FIG. 30. The prediction error over the test set trajectories for the FC and LSTM variants are shown in FIG. 16. The GANDER abort capabilities over various abort thresholds a are shown in FIG. 17 for FC and FIG. 18 for LSTM classification approaches.

To understand the sensitivity of GANDER to the relative training dataset sizes, a series of ablation studies were performed on Task 2, reducing the sizes of the training sets tor both the VAEGAN and classifier components. This set of studies ablated the training sets while leveraging the original full validation and test sets.

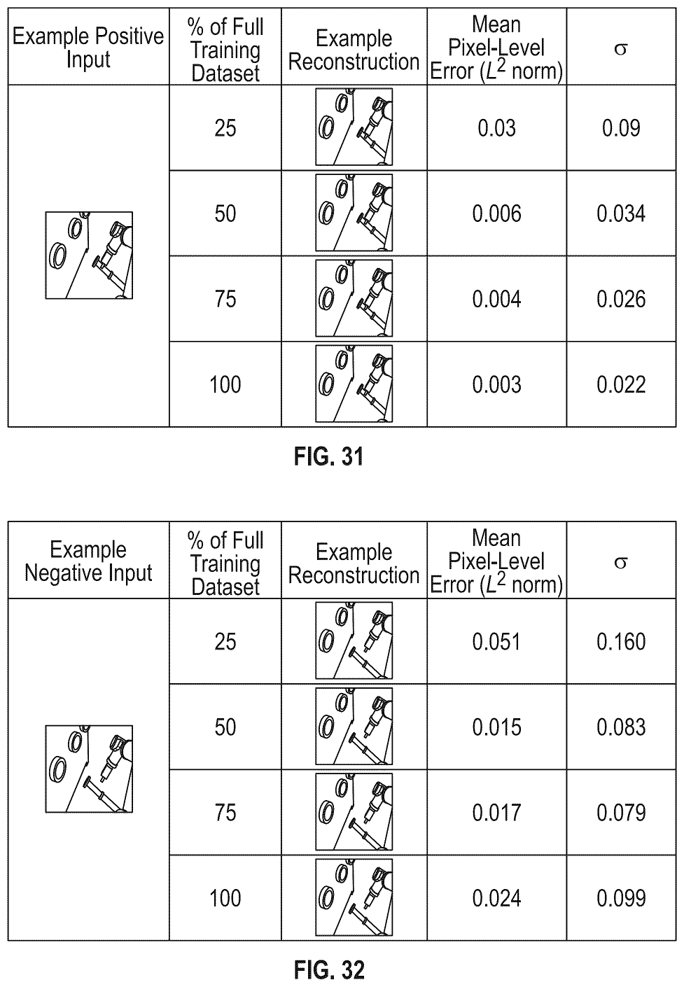

VAEGAN training data size The VAEGAN training dataset was ablated 3 times, creating datasets of 100% (112000 images), 75% (84000 images), 50% (56000 images), and 25% (28000 images) of the original Task 2 positive manifold dataset. Hyperparameters were held constant for each model, each which was trained for 100 epochs. The mean pixel-level (E2-norm) and standard deviation is reported in FIG. 31 for positive images in the test set and FIG. 32 for negative images in the classifier test-set. Representative images from the datasets are also included in order to capture reconstruction quality and the ability of the network to map negative outcomes to the positive manifold.

It was expected that ablating the VAEGAN training dataset would diminish its ability to reconstruct images on the positive manifold. However, even when ablating the VAEGAN training set considerably, key aspects of the task appear to be mapped. As the amount of ablation increases, the reconstructions do become noisier/blurrier. In FIG. 31, this manifests by an increase in pixel-level errors between the input and reconstructed images as the dataset size decreases. As these inputs are on the positive manifold, large modifications to the images during mapping would not be expected. In FIG. 32, this noise manifests through a decrease in pixel-level errors between the input and reconstructions as the training dataset size decreases. This is because as the dataset training size decreases, the mapping capability of the VA EGAN diminishes. A “true” mapping should induce high pixel-level errors as the input image will need to be considerably changed.

In order to quantify how much annotated data is necessary for an exemplary GANDER system, an ablation study was performed with respect to the amount of labeled training data for the classifiers. For these studies the VAEGAN component of the exemplary GANDER system was frozen, using a model trained on the full positive manifold dataset, and retrained the classifier 5 times for 100 epochs. If model loss plateaued prior to 100 epochs, training was ended early. The same full test of 200 trajectories (split evenly between positive and negative) was used to evaluate all ablations. Training data was evenly split across positive and negative trajectories. Each consecutive training set ablated the training set by 50%-yielding annotated training dataset sizes of 2000 trajectories/258145 images (100%), 1000 trajectories/29033 images (50%), 500 trajectories/14535 images (25%), and 250 trajectories/7249 images (12.5%).

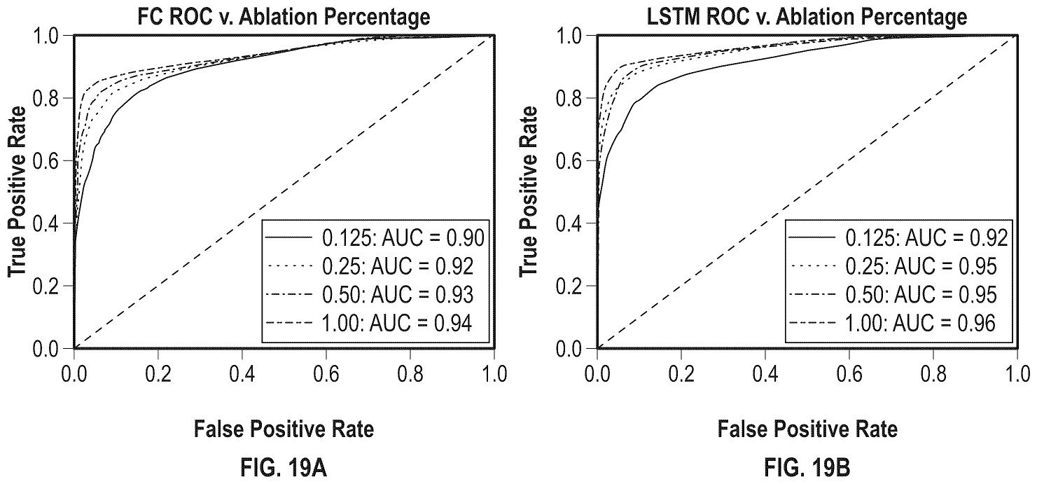

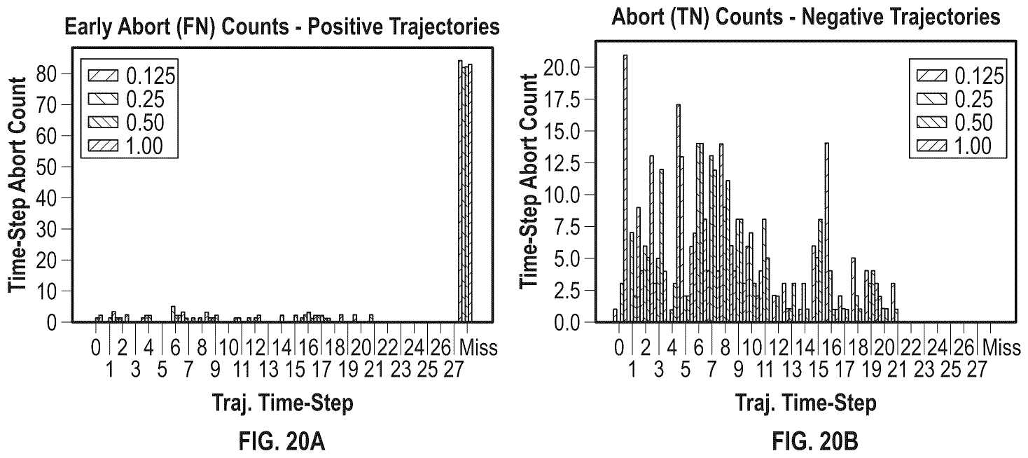

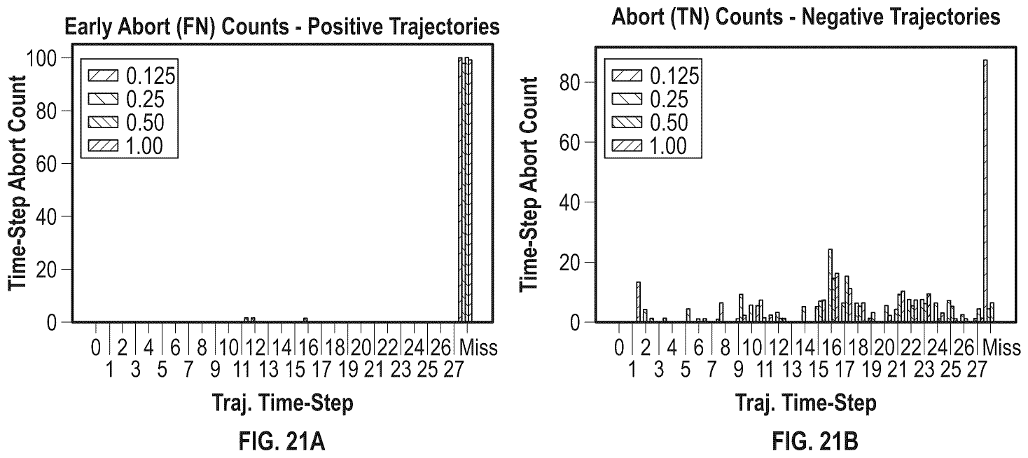

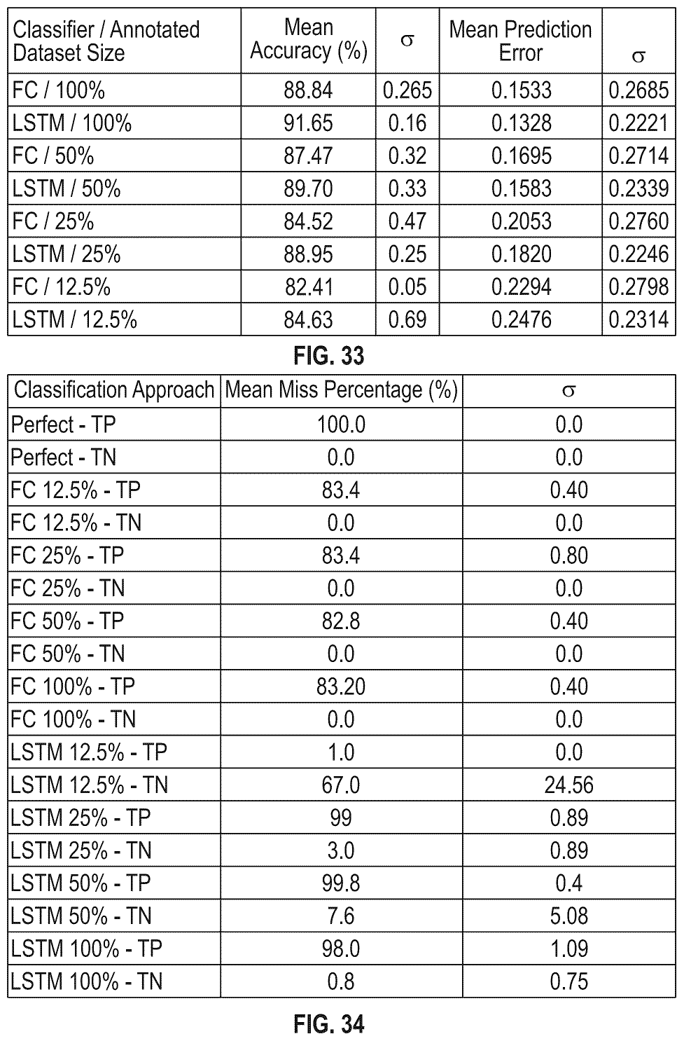

Summary performance measures (accuracy and prediction error) of the trained models are enumerated in FIG. 33. ROC curves for the ablated models are included in FIG. 19. As expected, with reduced training data the performance of the classifiers diminishes. However, their performance indicates that reduced classifier dataset size may be possible without severe reduction in performance. The ability of the ablated models to abort when P(success)<0.05 is tabulated in FIG. 34. Trajectory-wide abort performance is shown in FIG. 20 for the FC classifier and FIG. 21 for the LSTM classifier. The FC classifier tended to be more aggressive, detecting all TN in all cases at the expense of increased FN. The LSTM meanwhile, traded a reduction in FN for a slight decrease in TN detection capability. Recurrent approaches typically need large amounts of training data. As such, the failure of the LSTM (in terms of abort capability) at the 12.5% threshold is not surprising, although it is disappointing. This result indicates that a lower limit for training dataset size for the LSTM exists for a specific a threshold, where P(success)<a is the threshold to stop the robot. As collecting the annotated datasets is likely the most expensive part of data collection, the overall performance of the GANDER system as the annotated training dataset sizes are reduced is encouraging.

The performance of the two variants of the GANDER system described above (FC and LSTM classifier versions) were also compared with four baseline approaches:
1. A fully connected classifier trained directly on the annotated task data,
2. A fully connected classifier trained on the convolutional features of the images in the annotated task data,
3. A VAE based variant of GANDER where a VAE maps images to the positive manifold in place of the VAEGAN fed to a fully connected classifier {VAE FE FC),
4. A VAE based variant of GANDER where a VAE maps images to the positive manifold in place of the VAEGAN fed to a LSTM (VAE FE LSTM).

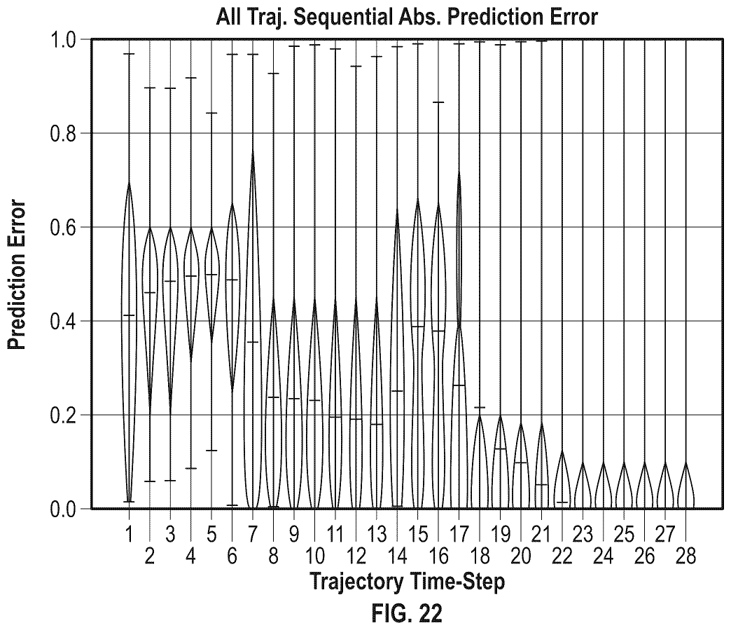

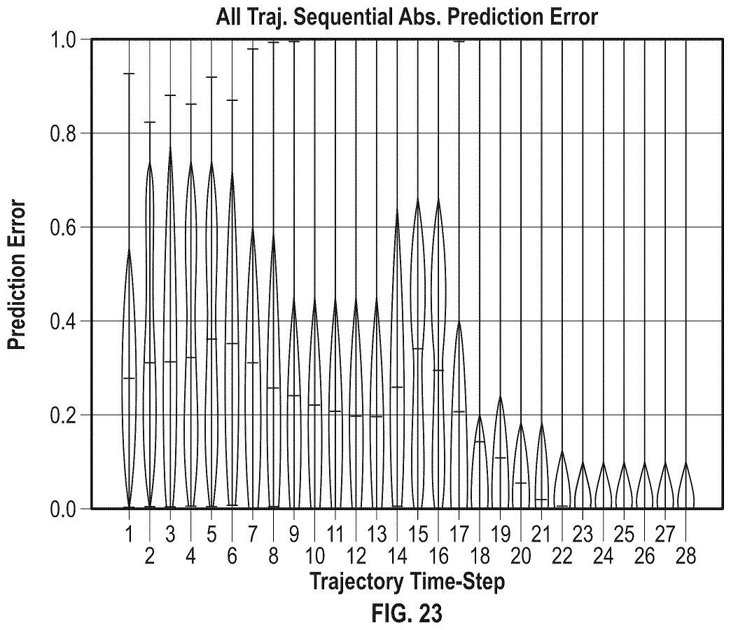

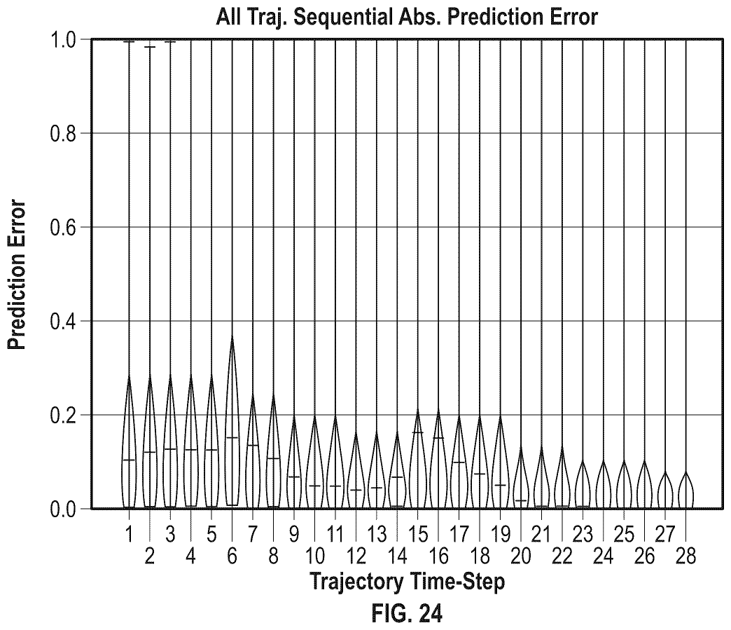

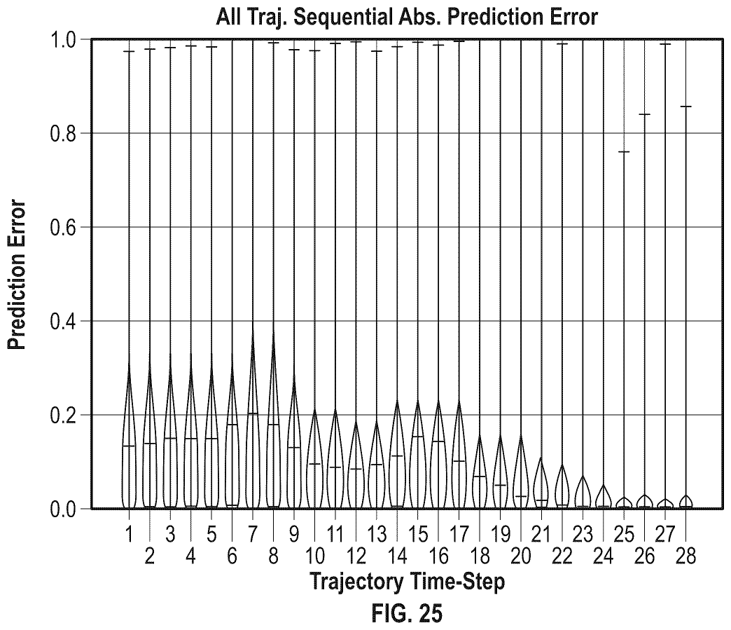

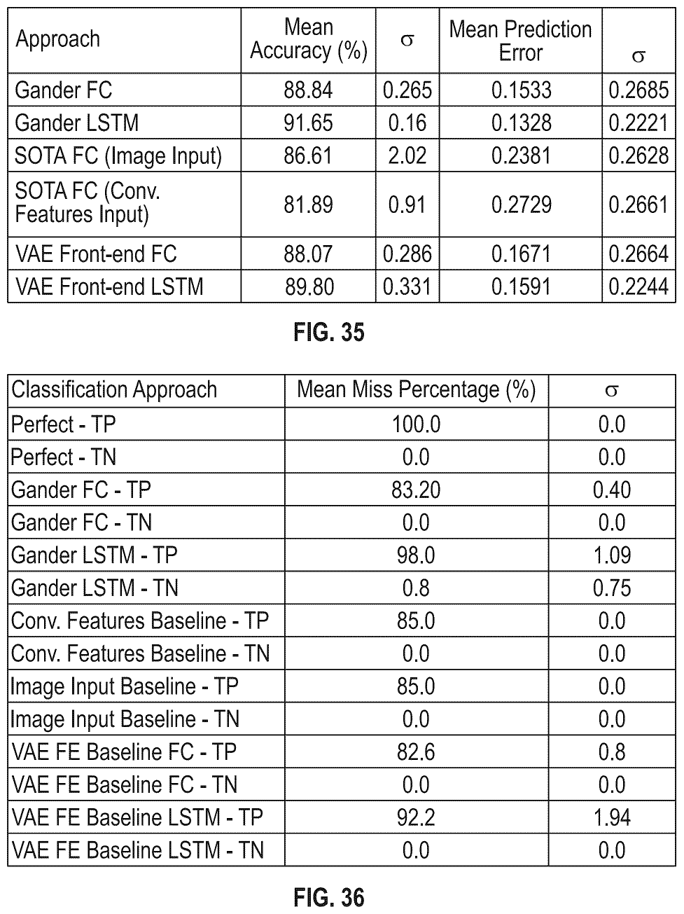

Each approach was evaluated in Task 2, the lunar maintenance domain. Each approach was trained 5 times on the full classifier (annotated) dataset in order to accumulate some statistics on performance. The per-image accuracy of the resulting models on the Task 2 dataset is shown in FIG. 35. On pure classification, the GANDER variants outperform the baseline systems. Each baseline's ability to trigger aborts in test trajectories is summarized in FIG. 36. While most models were quite sensitive to TN in Task 2, most models only had a fair TP performance. Of note is the GANDER LSTM variant, which scored the highest on TP while missing a very small number of TN. This lowered TN performance may be due to the inherent stochasticity of the trained models. The prediction errors over the trajectories for the baseline FC approaches are shown in FIGS. 22 and 23 and in FIGS. 24 and 25 for the VAE front-end baselines. Compared to the GANDER LSTM prediction errors (FIG. 16B), the FC baseline approaches (FIGS. 22, 23) have higher prediction error throughout the trajectory until the very end of the trajectory. The VAE-front-end approaches have similar performance to GANDER, though have slightly higher prediction errors throughout the trajectory.

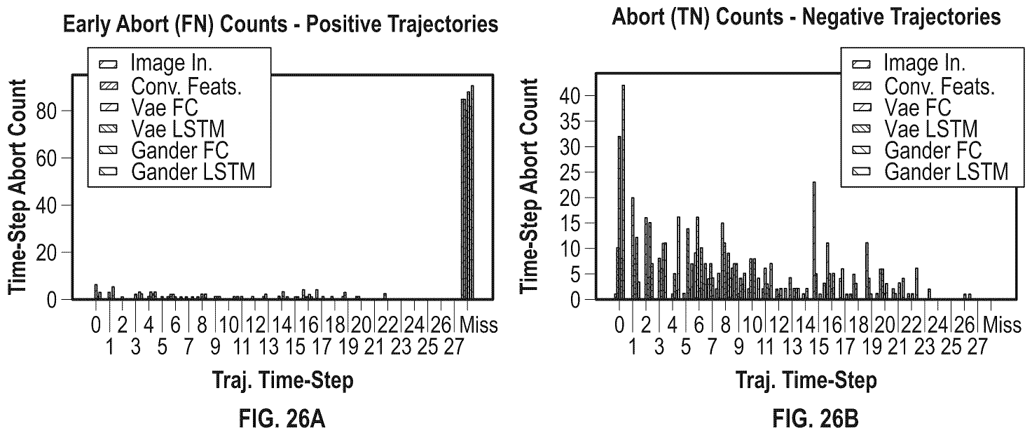

The direct image and convolutional feature baselines performed poorly compared to the generative models (GANDER and VAE FE). The abort plots for the baselines and GANDER are shown in FIG. 26.

The above-described failure detection can provide the foundations for fail-active behaviors, that is, behaviors that allow a robot to fail without damaging itself or the environment. Such capability further opens the door for fault recovery behaviors—the robot will still be functional even after a failed execution and can attempt to remedy the failure. Using principles of shared autonomy, an exemplary GANDER system can alert a remote operator that a failure has been detected or engage additional tools, such as finite state automata or behavior trees, to execute recovery processes.

In some embodiments, a GANDER system desirably utilizes negative samples from the target domain to train the classifier to detect poor direct reconstructions, such as those shown in FIG. 32, that map negative input images to the positive manifold. Collecting negative instances from the domain of interest (even hundreds of samples), however, can be prohibitively expensive or impossible in many settings due to inherent danger or lack of known failure cases. To accommodate such circumstances, the GANDER system could leverage high-entropy images, such as white Gaussian noise as the negative inputs. These high-entropy images would potentially cover the range of inputs we would expect. However, the VAEGAN is not exposed to such high entropy images during training—the current loss formulation (Equation 1) (specifically for the encoder and decoder) only receives updates from the training data—so disparity in reconstruction quality is expected. Further, reconstructing such noise with the current system fails to map the input to the positive manifold. As such, classifier should not be relied upon alone to bypass collecting negative training data.

One method to address this would be to modify how the VAEGAN network is trained. If a set of off-domain images Y is included in the input image set X, Y ⊂X, such that “real” samples used in training x are sampled {x|x∈X∧∉Y} while samples used to generate “fake” images are drawn {x|x∈X} the learned image mappings can be improved to handle a wider variety of inputs while not penalizing the ability of the system to map input images to the positive manifold.

Another method to address this may be to directly modify the VAEGAN loss (Equation 1 above) to cover a larger amount of the latent space by adding a new term, Loff, where

$${Off}_{} = log ( Dis ( Gen ( Enc ( y ) ) ) )$$

where y˜Y, with Y being a set of off-domain images. The addition of this term should increase the VAEGAN's ability to map images off the positive manifold to the positive manifold. This addition does have the potential to unbalance the synthetic and real data terms (as discussed above), so decisions will need to be made in terms of how the different networks are updated with the resulting signal.

These possible approaches may reduce, or potentially eliminate, the need for annotated training data, as any off-domain images could be used instead. The classifier could then be trained to detect poor reconstructions as failures and accurate reconstructions as positives. Training the classifier in such an approach may require modifications. One such modification could be to feed the input and reconstruction images directly to the classifier instead of using the extracted features.

At the core of GANDER is a generative model that performs an image-to-image mapping. This mapping of images to the positive manifold then allows a classifier to discriminate between successful and failure case images. GANDER achieves this mapping via a VAEGAN, a model that combines VAE and GAN elements.

Recent advances in GAN state of the art could similarly be leveraged, such as VQ-GANs. Such an approach shares similarities with the VAEGAN approach (it combines a VAE and GAN), however it additionally leverages a Transformer network to quantize the latent space of the VAE. Transformer models have recently shown comparable performance to state-of-the-art image classification tasks with less requirements on compute resources. Attention-augmented recurrent models have also enabled longer “context” windows in classifying sequential data.

Although the foregoing, exemplary GANDER system was described in the context of simulation, directly collected data from deployed hardware could be used instead where feasible. To the extent simulation is required, recent advances have used GANs to transform images obtained from simulation to photo-realistic images to train deep-reinforcement learning algorithms. Such an approach eases training by using significantly easier to obtain simulated data, then transforming them to mimic data pulled from real robot operations.

Remote assembly and maintenance tasks will likely benefit the most from the GANDER system, as it will allow these systems to detect and react to faults at runtime. This becomes critical behavior as time delay in communications increases in off-world operations. Ground operations on Earth are also expected to benefit, as robots will be able to more reliably behave with greater autonomy.

Ultimately, the appropriate training data could be collected using a real system or rely (in whole or in part) on simulation data. The benefits of autonomous data collection in simulation would increase the applicability of GANDER. As such, the application of recent advances in transfer learning, such as CycleGANs, to facilitate transferring the results of simulated training to real systems may be desirable for certain embodiments.

Additionally, GANDER may be incorporated into other, existing systems. To date, human spaceflight has relied on nearly continuous communications with minimal time delay. Ground-based mission control operations enabled by such communications have provided oversight in fault and anomaly detection while simultaneously providing solutions to the crew for such events, drawn from a vast pool of human experts. However, as NASA's goals and missions evolve past low-Earth orbit (LEO) to cislunar, lunar, and Martian missions, innovative cognitive architectures will be required to provide similar support mechanisms locally due to intermittent communications and long time delays.

Under previously funded NASA efforts, PRIDE, a procedure automation tool has been developed. PRIDE has been used successfully for mission operations both at NASA and commercial space companies. Several planned commercial and governmental lunar missions, including efforts from Sierra Space, Blue Origin, Intuitive Machines, and NASA are leveraging PRIDE to automate procedures. One of the strengths of PRIDE is its ability to leverage telemetry to inform automation. However, PRIDE lacks robust verification capabilities in tasks that do not directly provide telemetry, thus potentially limiting the scope of its broader deployment.

As described previously, GANDER leverages a generative model to perform error detection through mapping input images to a learned manifold that contains only positive outcomes. This approach has enabled error detection without the need for extensive negative labeled data, as classification can be achieved by simply determining if a mapped image lies on the positive manifold or not—images that do not lie on the manifold will be changed drastically through the mapping process. This enables error detection in settings where negative examples are limited, are dangerous to obtain, or are possibly unknown. Such conditions are expected to dominate spaceflight domains.

To address the need for more intelligent and responsive cognitive architectures to serve NASA's long-term vision for cislunar, lunar, and Martian missions, PRIDE may be integrated with GANDER to provide improved functionality.

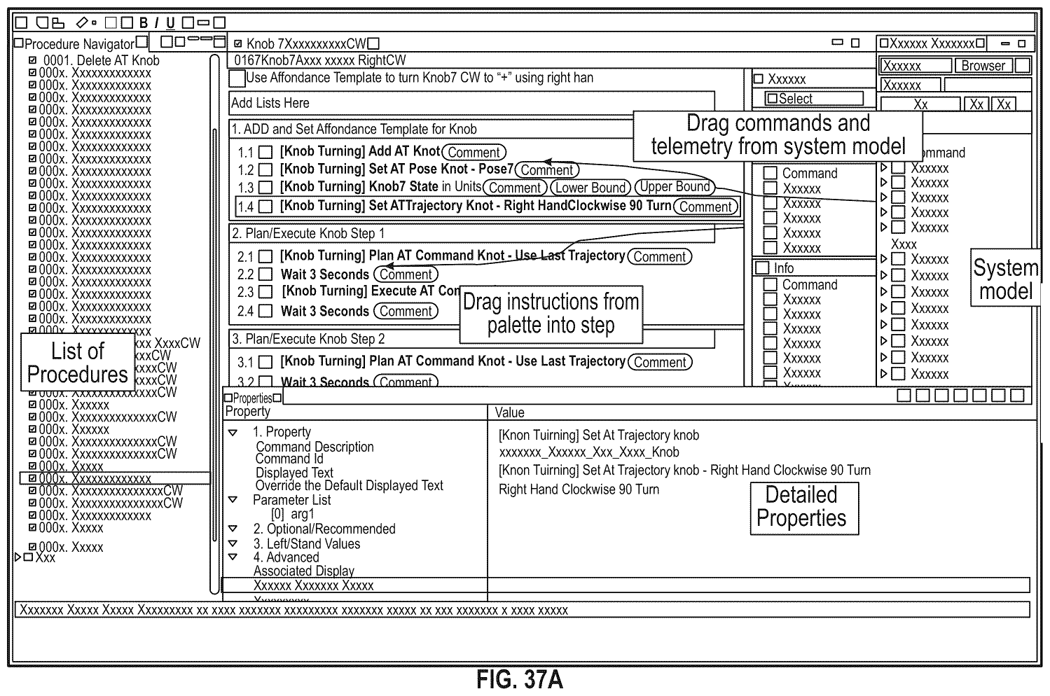

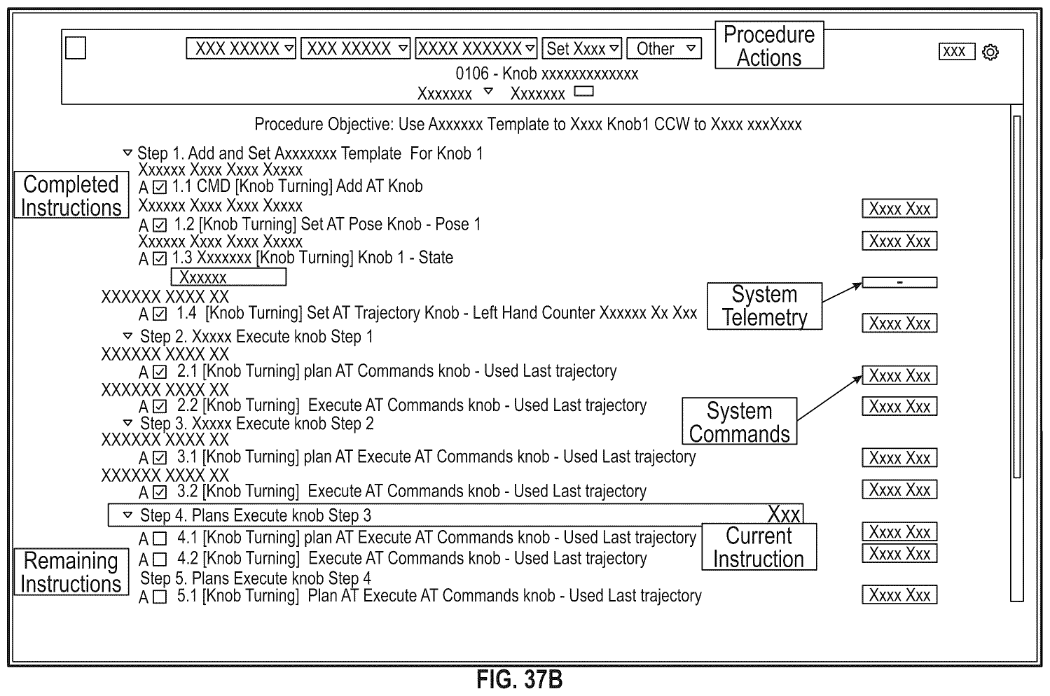

The PRIDE electronic procedure platform was developed to enable manual and automated execution of the standard operating procedures necessary for any crewed spacecraft. An authoring tool, Pride Author as shown in FIG. 37A, is used to create or modify procedures that also incorporate system telemetry and commands. Pride Author produces an extensible Markup Language (XML) file using a format called the Procedure Representation Language (PRL) that completely describes the procedure in a well-defined, structured way that can be automated. PRIDE's PRL is an extension of the International Space Station (ISS) electronic procedure format and is familiar to crew and ground controllers.

The procedure XML file is then translated into an HTML5 document and made available to the operator via the Pride View Server. The Pride View Server is a modern web server that browsers connect to for procedure execution (see FIG. 37B). The browser-based interface to PRIDE allows crew members to monitor automated procedure execution and intervene when manual execution is necessary. All interaction with a procedure, whether by automation or a crew member, is recorded in a database for auditing and optimization purposes.

Automation of a procedure is provided by a separate Pride Agent for Execution (PAX) module that can interpret the PRL and dispatch commands to the spacecraft and read telemetry from the spacecraft. Procedures can be run completely autonomously, completely manually or with a mix. The crew member can always see the current state of procedure execution and intervene if necessary.

The current PRIDE platform is already extensively used by NASA, by commercial space companies such as Blue Origin, Intuitive Machines, and Sierra Space, and by large energy and chemical manufacturers. The work in this proposal will augment the basic PRIDE platform with the capability to recognize correct actions using generative models trained on visual images. This will greatly enhance the safety of both automated and manual procedure execution.

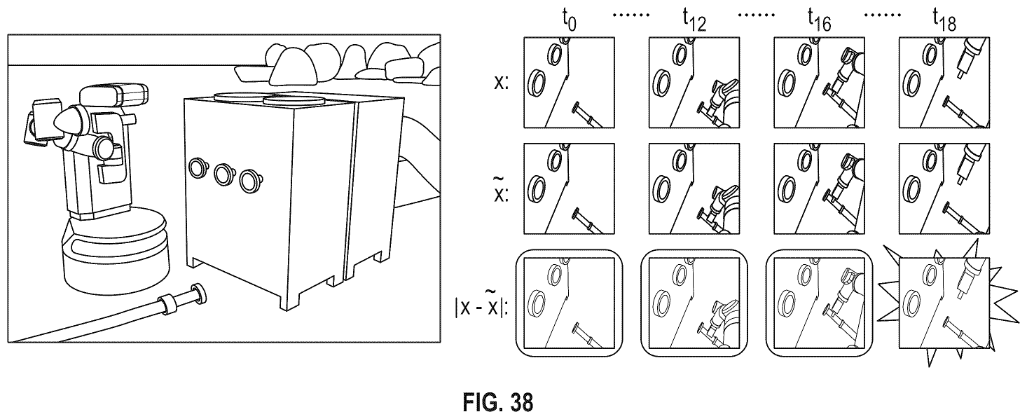

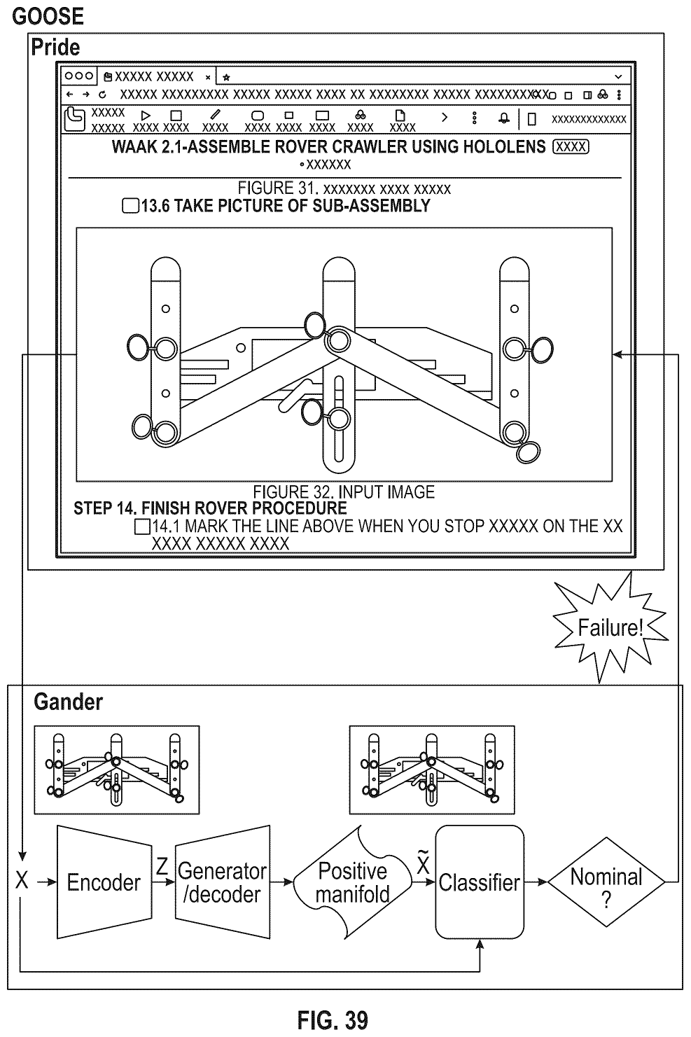

An integrated GANDER system would function as previously described. It would extract features from an original input image, a reconstruction, and the GAN discriminator to train a classifier that predicts the probability of task success. FIG. 38 illustrates an exemplary use. When GANDER predicts low confidence in task outcomes lying on the positive manifold, P(success)<α, further motions are aborted.

The integration of GANDER into systems like PRIDE can satisfy the need for a cognitive architecture in cislunar, lunar, and Martian missions. The PRIDE system provides a vetted tool to direct and inform crew through procedures to both maintain craft/habitat health and perform science tasks. When paired with the verification capabilities provided by GANDER, an intelligent, responsive, and reactive tool emerges that can trigger alarms or even corrective procedures as needed when failures are detected during and/or at the conclusion of procedures. The resulting system may provide similar support mechanisms as ground-based mission control without being impacted by intermittent communications or long time delays.

A system diagram of the proposed, integrated system with an example use is shown in FIG. 39. In this instance, a crew member is completing a task to assemble a rover in PRIDE. At the shown step of the procedure, the crew member has completed a sub-assembly and has taken a snapshot image of their progress. This snapshot is fed to a trained GANDER model for this specific sub-assembly. The model detects a disparity between the input and the reconstructed image (the rover legs were assembled upside down) and reports back to PRIDE that an error was detected. At this point, PRIDE could either alert the user something was wrong, engage a sub-procedure to rectify the fault, or restart the current procedure. The error detection and fault mitigation facilitated by GOOSE will help assuage the lost oversight capabilities currently provided by ground-based mission control.

While disclosed embodiments have been shown and described, modifications thereof may be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters may be varied. Accordingly, the scope of protection is not limited to the embodiments described herein, but is only limited by the claims that follow, the scope of which shall include all equivalents of the subject matter of the claims.

What is claimed is:

1. A system for detecting off-nominal behavior comprising:
a trained manifold developed with a target behavior dataset;
an encoder configured to receive at least one initial data element, said encoder being further configured to generate a lower dimensional data element from said at least one initial data element;
a generator configured to generate a reconstructed data element by mapping said lower dimensional data element onto said trained manifold; and
a classifier configured to measure a divergence between said initial data element and said reconstructed data element wherein a divergence beyond a pre-determined threshold is indicative of off-nominal behavior.

2. The system of claim 1 wherein said target behavior dataset includes only nominal behavior data.

3. The system of claim 2 wherein said at least one initial data element corresponds to a measured state of a robotic system and said nominal behavior data corresponds to a set of target states for said robotic system.

4. The system of claim 3 wherein said nominal behavior data comprises simulated behavior data.

5. The system of claim 3 wherein said classifier is a fully-connected classifier.

6. The system of claim 3 wherein said classifier is a long short-term memory classifier.

7. The system of claim 3 further comprising a robotics control platform coupled to said robotic system, wherein said robotics control platform is configured to cause said robotic system to terminate an operation upon said classifier determines divergence of said initial data element and said reconstructed data element beyond said pre-determined threshold.

8. A system for detecting off-nominal behavior comprising:
a robotic control platform configured to observe and control operations of a robotic system,
said robotic control platform comprising:
a user interface configured to allow a user to remotely direct operations of said robotic system;
a trained manifold developed with a target behavior dataset;
an encoder configured to receive at least one initial data element, wherein said user interface is further configured to allow said user to cause said at least one initial data element to be communicated to said encoder, said encoder being further configured to generate a lower dimensional data element from said at least one initial data element;
a generator configured to generate a reconstructed data element by mapping said lower dimensional data element onto said trained manifold; and
a classifier configured to measure a divergence between said initial data element and said reconstructed data element wherein a divergence beyond a pre-determined threshold is indicative of off-nominal behavior, said user interface being further configured to notify said user upon said classifier detecting said off-nominal behavior.

9. The system of claim 8 wherein said target behavior dataset includes only nominal behavior data.

10. The system of claim 9 wherein said at least one initial data element corresponds to a measured state of said robotic system and said nominal behavior data corresponds to a set of target states for said robotic system.

11. The system of claim 10 wherein said classifier is a fully-connected classifier.

12. The system of claim 10 wherein said classifier is a long short-term memory classifier.

13. The system of claim 10 wherein said nominal behavior data comprises simulated behavior data.
